(19) United States
(12) Patent Application Publication
(10) Pub. No.: US 2025/0173545 A1
(43) Pub. Date: May 29, 2025

(54) MODULATION-SPECIFIC COMPONENTS FOR RECONFIGURABLE NEURAL NETWORK-BASED RECEIVERS

(71) Applicant: NVIDIA Corporation, Santa Clara, CA (US)

(72) Inventors: Sebastian Cammerer, Tuebingen (DE); Reinhard Wiesmayr, Zürich (CH); Faycal Ait Aoudia, Santa Clara, CA (US); Jakob Richard Hoydis, Paris (FR); Alexander Georg Keller, Berlin (DE)

(21) Appl. No.: 19/030,900

(22) Filed: Jan. 17, 2025

Related U.S. Application Data
(63) Continuation-in-part of application No. 18/233,203, filed on Aug. 11, 2023.
(60) Provisional application No. 63/405,264, filed on Sep. 9, 2022.
(60) Provisional application No. 63/675,719, filed on Jul. 25, 2024.

(51) Int. Cl. G06N 3/04

(52) U.S. Cl. CPC G06N 3/04

(57) ABSTRACT

Embodiments of the present disclosure relate to modulation-specific components for reconfigurable neural network-based receivers. A neural receiver (NRX) may be used in a wireless communication systems and method. The NRX performs symbol demapping simultaneously in a reconfigurable multi-user multiple-input multiple-output (MU-MIMO) system, where one or more of the modulation and coding (MCS) schemes are different and variable. The reconfigurable MU-MIMO NRX includes MCS-specific components at an input and output layer and modulation independent intermediate layers between the input and output layers. The reconfigurable MU-MIMO NRX may be jointly trained for multiple MCSs and for system property variations (different learned weights for each system property variation).

### CLAIM OF PRIORITY

This application claims the benefit of U.S. Provisional Application No. 63/675,719 titled “Modulation-Specific Components for Reconfigurable Neural Network-Based Receivers”, filed Jul. 25, 2024, the entire contents of which are incorporated herein by reference. This application is a continuation-in-part of the U.S. Non-Provisional application Ser. No. 18/233,203 titled “Frequency Division Multiplexing with Neural Networks in Radio Communication Systems”, filed Aug. 11, 2023, which claims the benefit of U.S. Provisional Application No. 63/405,264 filed Sep. 9, 2022, the entire contents of both are incorporated herein by reference.

### BACKGROUND

One of the major drawbacks of existing neural receiver (NRX) approaches is the lack of flexibility for varying system parameters and, thus, the need for re-training if any parameter changes. In particular, for multi-user MIMO, a receiver needs to support different modulation and coding schemes (MCS) for each user, and the receiver should be able to re-configure the system within milliseconds (or even less). The vast number of different system parameter combinations makes it impossible to train a specific NRX for each possible system setup. There is a need for addressing these issues and/or other issues associated with the prior art.

### SUMMARY

Embodiments of the present disclosure relate to modulation-specific components for reconfigurable neural network-based receivers. Systems and methods are disclosed for machine learning-based signal processing algorithms for wireless communications. In particular, a neural receiver (NRX) implements a single neural network to perform wireless channel estimation, multi-antenna equalization, and symbol demapping altogether.

A drawback of existing NRX approaches is the lack of flexibility for varying system parameters and, thus, the need for re-training if any parameter changes. In particular, for multi-user MIMO, a receiver needs to support different MCSs for each user, and it must be able to re-configure the system within milliseconds (or even less). The vast number of different system parameter combinations makes it impossible to train a specific NRX for each possible system setup. Therefore, existing neural receivers have a static MCS for all users.

In contrast to conventional systems, a reconfigurable NRX includes modulation-specific components to support different MCSs per user while maintaining the strong block-error-rate (BLER) performance. The reconfigurable NRX performs the symbol demapping simultaneously, where one or more of the MCSs are different and variable, providing sufficient flexibility for practical multi-user multiple-input multiple-output (MU-MIMO) systems. A reconfigurable MU-MIMO NRX includes MCS-specific components at an input and output layer and modulation independent intermediate layers between the input and output layers.

In an embodiment, a system and method for reconfiguring a receiver neural network includes a neural network receiver model configured to receive a plurality of received (RX) signals comprising a plurality of transmitted (TX) streams and determine a plurality of TX data symbols included in the plurality of TX streams. The receiver neural network comprises a first input layer for processing at least a first portion of the plurality of the RX signals encoded using a first modulation and coding scheme (MCS) to produce first state tensors, a second input layer for processing at least a second portion of the plurality of the RX signals encoded using a second MCS to produce second state tensors, and intermediate layers for processing both the first state tensors and the second state tensors using a single set of learned parameters to produce processed first state tensors and processed second state tensors. The receiver neural network further comprises a first output layer for projecting the processed first state tensors to generate first reliability estimates for bit values of first TX data symbols in the plurality of TX data symbols and a second output layer for projecting the processed second state tensors to generate second reliability estimates for bit values of second TX data symbols in the plurality of TX data symbols. In an embodiment, the single set of learned parameters is shared between users with the same MCS. In an embodiment, each user is associated with a different (dedicated) input layer.

### BRIEF DESCRIPTION OF THE DRAWINGS

The present systems and methods for modulation-specific components for reconfigurable neural network-based receivers are described in detail below with reference to the attached drawing figures, wherein:

FIG. 1 is a block diagram of an example wireless communication system that uses neural networks to implement multi-user MIMO OFDM operations, in accordance with at least some embodiments;

FIG. 2 illustrates an example neural network architecture of an OFDM model capable of supporting MIMO OFDM operations, according to at least one embodiment;

FIG. 3 illustrates one example construction of a positional encoding that may be used by the OFDM model, according to at least one embodiment;

FIG. 4A illustrates an example architecture of an initialization stage of the OFDM model of FIG. 2, according to at least one embodiment;

FIG. 4B illustrates an example architecture of an inter-stream interference identification stage of the OFDM model of FIG. 2, according to at least one embodiment

FIG. 5A illustrates an example architecture of a state update stage of the OFDM model of FIG. 2, according to at least one embodiment;

FIG. 5B illustrates an example architecture of a readout stage of the OFDM model of FIG. 2, according to at least one embodiment;

FIG. 5C is a flow diagram of example method of using neural network models for transmitted signal determination in communication systems that deploy orthogonal frequency division multiplexing, according to some embodiments of the present disclosure;

FIG. 6A illustrates an example block diagram of a MU-MIMO NRX (neural receiver) with variable MCS support, according to at least one embodiment;

FIG. 6B illustrates another example block diagram of a MU-MIMO NRX (neural receiver) with variable MCS support, according to at least one embodiment;

FIG. 6C illustrates an example training configuration for the MU-MIMO NRX 600, according to at least one embodiment;

FIG. 6D illustrates a flowchart of a method of using a neural network receiver model for transmitted signal determination in communication systems, in accordance with an embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating, and deploying machine learning models in an advanced computing pipeline, according to at least one embodiment.

### DETAILED DESCRIPTION

A neural receiver (NRX) is a single neural network that is trained to perform wireless channel estimation, multi-antenna equalization, and symbol demapping altogether, and possibly even perform forward error correction decoding. These algorithms executed by an NRX offer several benefits as compared to conventional baseline algorithms, such as a) site-specific adaptation to real-world environments and continuous improvements after deployment, b) better error rate performance when compared to a multitude of conventional algorithms with similar computational complexity, and c) enable various new communication paradigms including custom constellations for pilotless communications.

Systems and methods are disclosed related to modulation-specific components for reconfigurable neural network-based receivers. A neural receiver (NRX) may be used in wireless communication systems and wireless communication methods. The NRX performs symbol demapping simultaneously in a reconfigurable multi-user multiple-input multiple-output (MU-MIMO) system, where one or more of the modulation and coding schemes (MCS) are different and variable. The reconfigurable MU-MIMO NRX includes MCS-specific components at input and output layers (stages) and modulation independent intermediate layers between the input and output layers. The reconfigurable MU-MIMO NRX may be jointly trained for multiple MCSs and for system property variations (different weights may be learned for each system property variation).

Before describing the reconfigurable MU-MIMO NRX that includes MCS-specific components, a neural network architecture for a MU-MIMO orthogonal frequency-division multiplexing (OFDM) NRX is described. The OFDM NRX includes three stages, an initialization stage, unrolled iterative algorithm stage (inter-stream interference identification stage, inter-stream aggregation function, and state update stage), and a readout stage. In an embodiment, the OFDM NRX is trained to use a static MCS scheme for all users. Compared with the OFDM NRX, in the reconfigurable MU-MIMO NRX at least one of the initialization stage or the readout stage is replaced with reconfigurable components which are trained to support multiple MCS-specific input and output layers.

### Frequency Division Multiplexing with Neural Networks in Radio Communication Systems

In wireless transmissions that use OFDM, a bit stream is divided into multiple streams modulating different orthogonal frequency subcarriers ƒ that are then combined into a transmitted signal. A Discrete Fourier Transform is used on the receiving side to demodulate the subcarriers. Bits transmitted over individual subcarriers are grouped into symbols that are typically interspersed with guard intervals. The presence of guard intervals improves resilience of the wireless communications against echoes and interferences caused by signal propagation delays. Multiple input-multiple output (MIMO) technology increases capacity of radio communications by deploying multiple transmission and receiving antennas to exploit signal propagation over multiple distinct paths, which are engineered using interference-based beamforming techniques for directional transmission. In MIMO spatial multiplexing, individual signals are transmitted by a separate transmission (TX) antenna, received by receiver (RX) antenna(s), and combined by the RX device. Such combining is possible provided that the RX device has accurate channel state information (CSI) for radio signals arriving at an RX antenna array along different communication paths. CSI characterizes how a signal transmitted from a particular TX antenna is delayed, scattered, attenuated, etc., along a path to a given RX antenna. Multi-user MIMO (MU-MIMO) deploys MIMO technology for wireless communication, in which multiple users communicate with a base station in parallel using multiple TX and RX antennas.

A MU-MIMO communication system deploying OFDM technology may include multiple TX antennas (which may be connected to a single or multiple devices) transmitting N_{T} streams of data (e.g., N_{T}=2, 3, 4, 8, 12, 16 or any other number of TX streams) that are received by N_{R} RX antennas. In some instances, a single TX stream may be transmitted by more than one antenna. In some instances, a single TX antenna may transmit more than one stream. The number of streams may change over time, between one and a maximum number of streams N_{T-max} supported by the RX side. In some embodiments, the RX antennas may be connected to a single device or multiple devices that share computing resources, e.g., a protocol stack, and processor. Each stream may be transmitted over multiple N_{F} frequency subcarriers (e.g., N_{F}=64,256,1024 or any other number of subcarriers). A group of N_{S} symbols transmitted (over a certain time and evaluated jointly on the RX side) by the TX antennas over various frequency subcarriers is denoted herein as {Xₙ_{_{ƒ}}_{,n}_{_{S}}(n_{T})} where index n_{ƒ} enumerates subcarriers (1≤n_{ƒ}≤N_{F}), index n_{S} enumerates symbols (1≤n_{S}≤N_{S}), and argument n_{T} enumerates TX channels (1≤n_{T}≤N_{T}). A given symbol X may be a vector that includes any number K of bits (e.g., K=2, 4, 8, 16, or any other number of bits). Vector X may be modulated to a predefined constellation and labeling, such as quadrature amplitude modulation (QAM) with Gray labeling, in one example. The N_{F}×N_{S} set of subcarriers and transmitted symbols is referred to as a resource grid herein, with a given element (n_{ƒ}, n_{S}) of the resource grid referred to as a resource element (RE). The number N_{F} of frequency subcarriers and the number N_{S} of transmitted symbols may also vary with time.

A signal received over RE (n_{ƒ}, n_{S}) via a particular n_{R}th antenna (1≤n_{R}≤N_{R}) of N_{R} RX antennas is denoted as Yₙ_{_{ƒ}}_{,n}_{_{S}}(n_{R}). For illustration, the relation between the transmitted signals and the received signals may often be approximated with a good accuracy as a linear relation (although the embodiments and techniques of the present disclosure are not limited to linear systems),

$${Y}_{{n}_{f} , {n}_{S}} ( {n}_{R} ) = {\sum }_{{n}_{T} = 1}^{{N}_{T}} {H}_{{n}_{f} , {n}_{S}} ( {n}_{R} , {n}_{T} ) \cdot {X}_{{n}_{f} , {n}_{S}} ( {n}_{T} ) + {W}_{{n}_{f} , {n}_{S}} ( {n}_{R} ) ,$$

where Hₙ_{_{ƒ}}_{,n}_{_{S}}(n_{R}, n_{T}) is an N_{R}×N_{T} channel state matrix (defined separately for each resource element) that represents the CSI of the communication system, and Wₙ_{_{ƒ}}_{,n}_{_{S}}(n_{R}) is an additive noise associated with radio wave propagation and reception. In some embodiments, the noise may be approximated as a white Gaussian noise and may further be approximated as being uncorrelated across different RX antennas and resource elements.

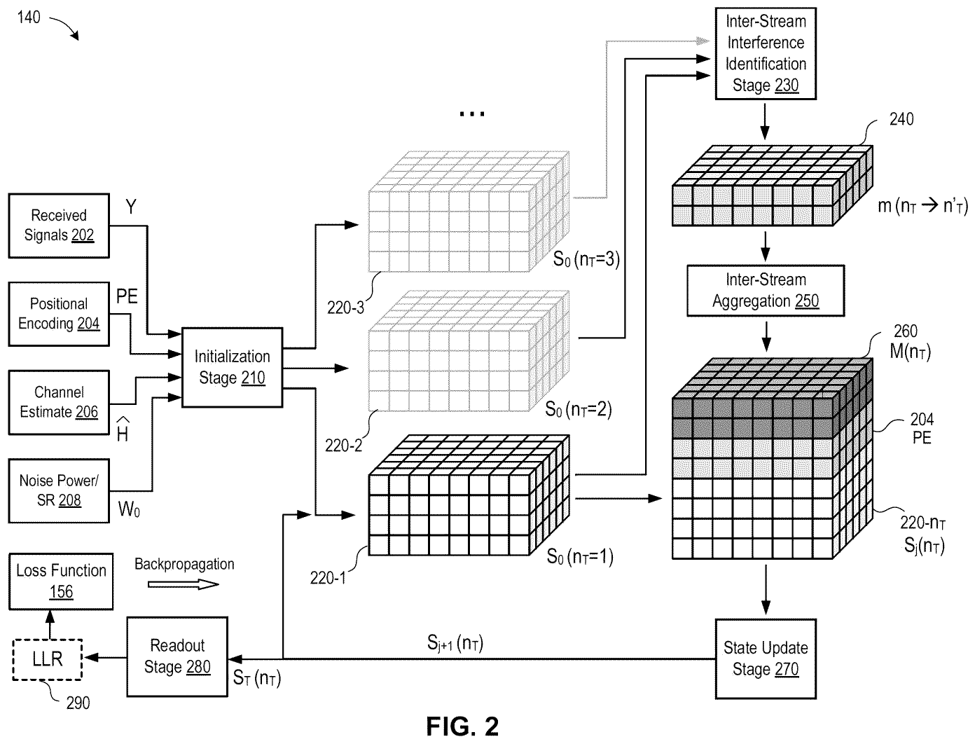

To identify transmitted signals Xₙ_{_{ƒ}}_{,n}_{_{S}}(n_{T}) based on received signals Yₙ_{_{ƒ}}_{,n}_{_{S}}(n_{R}), existing techniques aim to determine the channel state matrix and apply this matrix (or its inverse) to the received signals. In most existing techniques, this process is performed in two stages. In the first stage, the channel state matrix Hₙ_{_{ƒ}}_{,n}_{_{S}}(n_{R}, n_{T}) is estimated and, in the second stage, the inverse of the channel state matrix is applied to the received signals Yₙ_{_{ƒ}}_{,n}_{_{S}}(n_{R}). Channel state matrix estimation is typically performed using pilot REs. For example, as illustrated below in conjunction with FIG. 2, some of the REs may be reserved for transmission of predetermined (e.g., by the communication protocol) sequences of bits (vectors), Xₚᵢₗₒₜₛ(n_{T}), referred to as pilots. These known vectors Xₚᵢₗₒₜₛ(n_{T}) are used to estimate and extend (e.g., by interpolation and/or extrapolation) the channel state matrix to the entire resource grid. However, such extension is not always accurate, especially in systems with complex signal propagation and interference patterns. Moreover, such techniques often fail to account for intercarrier and/or intersymbol interference as well as various non-linearities (e.g., hardware impairments) that may be present. Recent applications of neural networks (NNs) to CSI estimation have been successful in single-input multiple-output (SIMO) systems, enabling joint CSI estimation and transmitted signal reconstruction, but appear to be less accurate in MU-MIMO systems.

Aspects and embodiments of the present disclosure address these and other technological challenges by disclosing techniques and systems that use NNs, e.g., graph NNs (GNNs) that combined with convolutional neuron layers, to achieve accurate joint CSI estimation and transmitted signal reconstruction for MU-MIMO OFDM systems. Convolutional NN techniques enable capturing channel matrix correlations across different subcarriers and symbols whereas the GNN structure of the networks allows operating with a flexible number of streams N_{T}, number of frequency subcarriers N_{F}, and/or the number of transmitted symbols N_{S}. In some embodiments, a set of tensors may be generated and then iteratively updated, using the disclosed OFDM model, to obtain progressively more accurate representation of CSI. The set of tensors may be initiated using RX signals and, in some embodiments, positional encoding characterizing relative positioning of transmitted data symbols and pilot symbols and/or estimated (e.g., based on pilot received symbols) approximate channel state matrix.

Numerous other embodiments are described herein. The advantages of the disclosed techniques include but are not limited to a significantly lower block error rate (BLER) compared with conventional approaches.

### System Architecture

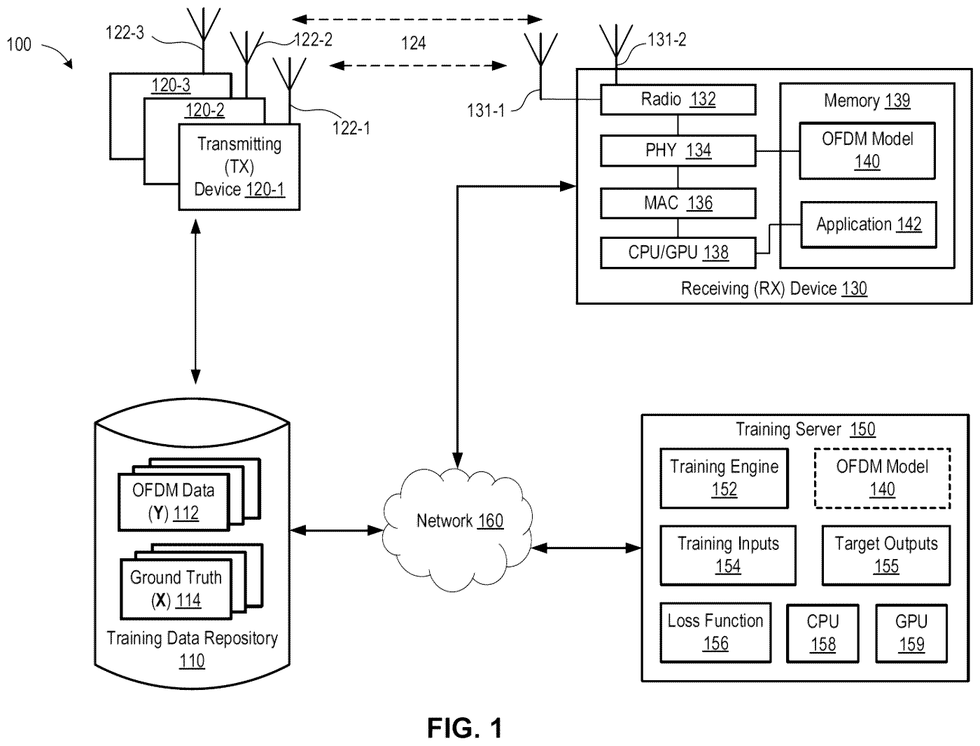

FIG. 1 is a block diagram of an example wireless communication system 100 that uses neural networks to implement multi-user MIMO OFDM operations, in accordance with at least some embodiments. As depicted in FIG. 1, the wireless communication system 100 may include a training data repository 110, one or more transmitting (TX) devices 120-k, a receiving (RX) device 130, a training server 150, and/or other devices not explicitly shown in FIG. 1. Although three TX devices 120-1, 120-2, and 120-3 are shown for concreteness, the number of TX devices 120-k need not be limited. Training data repository 110, RX device 130, and training server 150 may be connected to a network 160. Network 160 may be a public network (e.g., the Internet), a private network (e.g., a local area network (LAN), or wide area network (WAN)), a wireless network, a personal area network (PAN), a mesh network, and/or a combination thereof. In some implementations, a local bus/interconnect can be used in lieu of network 160, e.g., a Peripheral Component Interconnect Express (PCIe) bus, an NVLink®, and/or the like. TX devices 120-k and RX device 130 may be connected to a wireless (radio) communication channel 124. Wireless communication channel 124 may facilitate any suitable type of a wireless connection, including but not limited to wireless local area network (WLAN, e.g., Wi-Fi®) connection, a PAN (e.g., Bluetooth®) connection, a Long Term Evolution (LTE or 4G LTE) connection, a 5G connection, a mesh network (e.g., a BLE Mesh network, a Thread Mesh network, a ZigBee Mesh network, or any other type of a mesh network) connection, and/or the like. Each TX device 120-k may use one or more TX antennas 122-j for transmission of radio signals. (For conciseness and ease of viewing, each TX device 120-k is shown using one TX antenna 122-k, although this is not a limitation).

RX device 130 may operate in accordance with a wireless protocol utilized by the respective wireless network, e.g., one of IEEE 802 protocols, and may support a single radio band (e.g., 2.4 GHz band) reception or multiple radio band reception (e.g., both 2.4 GHz and 5 GHz bands). RX device 130 may use multiple RX antennas 131-k (two RX antennas 131-1 and 131-2 are shown for simplicity but the number N_{R} of RX antennas 131-k need not be limited). Any of the antennas 131-k may be capable of receiving and transmitting radio waves (although operations and techniques disclosed herein may be operating in conjunction with signals received by RX antennas 131-k).

A signal received by one or more RX antennas 131-k may be processed by radio module 132, which may include filters (e.g., band-pass filters), low-noise radio-frequency amplifiers, down-conversion mixer(s), intermediate-frequency amplifiers, analog-to-digital converters, forward/inverse Fourier transform modules, deparsing modules, interleavers, error correction modules, scramblers, and other (analog and/or digital) circuitry that may be used to process modulated signals received by RX antennas 131-k. Although a single radio module 132 is shown supporting multiple RX antennas 131-k, in some embodiments, separate radio modules may support different RX antennas 131-k. Radio module 132 may digitize the received signals and provide the digital signals to a physical layer component (PHY) 134. PHY 134 may compute Fast Fourier Transforms, determine modulation carried by the digitized signals, perform error correction, and assemble received data into frames. MAC layer 136 may transform frames into data packets, which may be used by CPU 138 (or GPU, DPU, PPU, and/or the like) to support operations of any suitable application 142 that is instantiated in memory 139 of RX device 130. In some implementations, operations of OFDM model may be supported by an application-specific integrated circuit (ASIC), a field-programmable gate array (FPGA), and/or some other suitable accelerator.

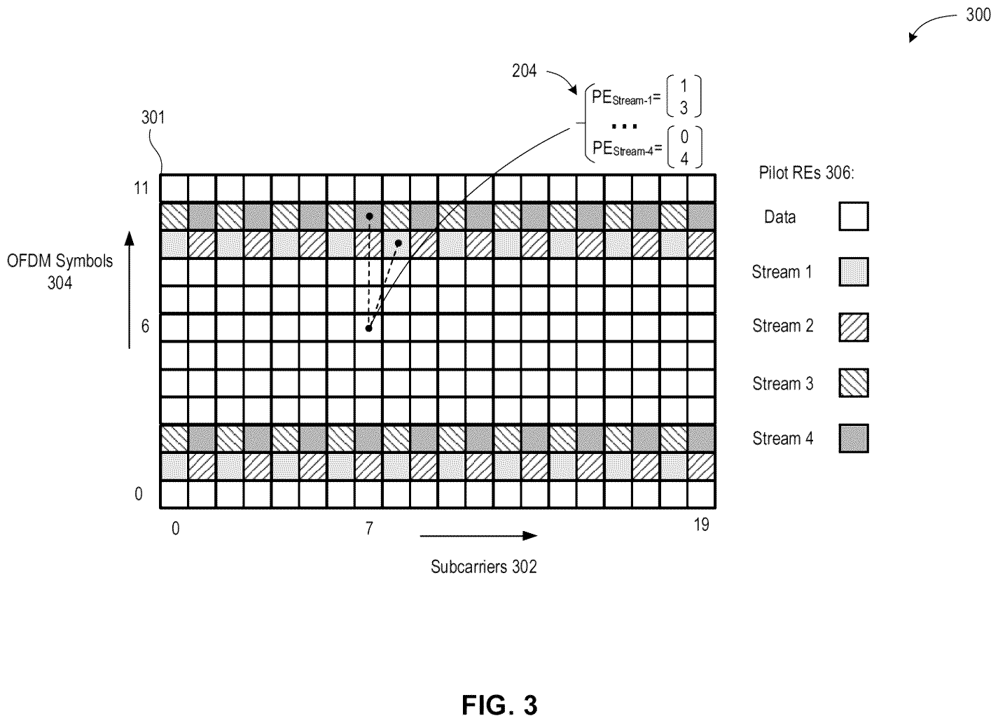

PHY layer 134 may perform MU-MIMO signal {Xₙ_{_{ƒ}}_{,n}_{_{S}}(n_{T})} reconstruction jointly with channel state estimation, e.g., using a trained OFDM model 140, as disclosed herein. In some embodiments, OFDM model 140 may have an architecture that is a combination of a convolutional NN (CNN) and a graph NN (GNN). A trained OFDM model 140 may process the received signals {Yₙ_{_{ƒ}}_{,n}_{_{S}}(n_{R})} together with certain pilot data (as disclosed in more detail below in conjunction with FIG. 3) and determine transmitted signals {Xₙ_{_{ƒ}}_{,n}_{_{S}}(n_{T})}. PHY layer 134 may then convert the transmitted signals into frames and provide the frames to MAC 136.

OFDM model 140 may be trained by a training server 150 using appropriate training data. In some embodiments, the training data may be stored in training data repository 110, including various OFDM data 112, e.g., training RX signals {Yₙ_{_{ƒ}}_{,n}_{_{S}}(n_{R})}, and ground truth 114, e.g., training TX signals {Xₙ_{_{ƒ}}_{,n}_{_{S}}(n_{T})}. In some embodiments, training data repository 110 may be a persistent storage capable of storing OFDM data 112 and ground truth 114 in any acceptable format. Training data repository 110 may be hosted by one or more storage devices, such as main memory, magnetic or optical storage disks, tapes, or hard drives, network-attached storage (NAS), storage area network (SAN), and so forth. Although depicted as separate from training server 150, in at least one embodiment, training data repository 110 may be a part of training server 150. In at least some embodiments, training data repository 110 may be a network-attached file server, while in other embodiments training data repository 110 may be some other type of persistent storage, such as an object-oriented database, a relational database, and so forth, that may be hosted by one or more other machines coupled to training server 150 via network 160.

Training server 150 may be and/or include a rackmount server, a router computer, a personal computer, a portable digital assistant, a mobile phone, a laptop computer, a tablet computer, a camera, a video camera, a netbook, a desktop computer, a media center, or any combination of the above. Training server 150 may deploy a training engine 152 to train OFDM model 140 using training data that includes training inputs 154 and corresponding target outputs 155. As described in more detail below, OFDM model 140 may include one or more deep neural networks, with one or more hidden layers, e.g., convolutional neural networks, recurrent neural networks (RNN), and fully connected neural networks. Neurons of OFDM model 140 may receive inputs from other neurons or from an external source and may produce an output by computing a sum of weighted inputs and a bias value (and, optionally, subject to an activation function). In one illustrative example, weights and biases may initially be assigned random values that are modified during training.

Training inputs 154 may include sets of received signals {Yₙ_{_{ƒ}}_{,n}_{_{S}}(n_{R})} and target outputs 155 may include sets of transmitted signals {Xₙ_{_{ƒ}}_{,n}_{_{S}}(n_{T})}. Training engine 152 may find patterns in the training data that map the training inputs to the target outputs (the desired result to be predicted), and train OFDM model 140 to capture these patterns. Differences between training inputs, e.g., predicted signals {\hat{X}ₙ_{_{ƒ}}_{,n}_{_{S}}(n_{T})}, and ground truth signals {Xₙ_{_{ƒ}}_{,n}_{_{S}}(n_{T})} may be quantified using a suitable loss function 156, e.g., a binary cross-entropy loss function or some other loss function. The quantified differences may be backpropagated through OFDM model 140 and various parameters (e.g., weights and biases) of OFDM model 140 may be adjusted to reduce the differences. This adjustment may be repeated until the error for a particular training input 154 satisfies a predetermined condition (e.g., falls below a predetermined error). Subsequently, a different training input 152 may be selected, a new output generated, and a new series of adjustments implemented, and so on, until OFDM model 140 is trained to a desired degree of accuracy. After OFDM model 140 is trained, the trained OFDM model 140 may be provided to RX device 130 for inference analysis of new OFDM data. For example, PHY 134 of RX device 130 may receive a new (runtime) set of signals {Yₙ_{_{ƒ}}_{,n}_{_{S}}(n_{R})} from radio module 132 and use the trained OFDM model 140 to identify a correct set of transmitted signals {Xₙ_{_{ƒ}}_{,n}_{_{S}}(n_{T})} based on the received signals {Yₙ_{_{ƒ}}_{,n}_{_{S}}(n_{R})}.

Training server 150 may include a memory (not shown in FIG. 1) communicatively coupled to one or more processing devices, such as one or more central processing units (CPU) 158 and/or one or more graphics processing units (GPU) 159, data processing units (DPUs), parallel processing units (PPUs), and/or the like. Training server 150 may store executable codes, libraries, and various dependencies of training engine 152. Training engine 152 may be executed by CPU 158, GPU 159, or both. In at least one embodiment, GPU 159 may include multiple cores, each core being capable of executing multiple GPU threads. Each core may run multiple threads concurrently (e.g., in parallel). In at least one embodiment, threads may have access to registers. Some or all cores may include a scheduler to distribute computational tasks and processes among different threads of the respective core. A dispatch unit may implement scheduled tasks on appropriate threads using various private registers and shared registers. In at least one embodiment, GPU 159 may have a (high-speed) cache, access to which may be shared by multiple cores. Furthermore, GPU 159 may include a GPU memory to store intermediate and/or final results (outputs) of various computations performed by GPU 159. In some embodiments, training engine 152 may determine which processes are to be executed on GPU 158 and which processes are to be executed on CPU 159.

### OFDM Model Architecture

FIG. 2 illustrates an example neural network architecture of an OFDM model 140 capable of supporting MIMO OFDM operations, according to at least one embodiment. In at least one embodiment, example NN architecture illustrated in FIG. 2 may be implemented, during the training stage of OFDM model 140, by training server 150. Since operations of OFDM model 140 during the training stage and the inference stage may be similar, with certain exceptions, the techniques disclosed in conjunction with FIG. 2 may be applicable to both stages. The exceptions may be related to use of a loss function, dropout of neurons (e.g., random neuron dropout to prevent overfitting), and/or other techniques that may be used during the training stage and not used during the inference stage.

As illustrated in FIG. 2, received signals {Yₙ_{_{ƒ}}_{,n}_{_{S}}(n_{R})} may be processed by an initialization stage 210, which may be implemented as a subnetwork of OFDM model 140. Initialization stage 210 converts K-bit received vectors Yₙ_{_{ƒ}}_{,n}_{_{S}}(n_{R}) into d-bit feature (encoding) vectors associated with N_{T} streams, e.g., N_{R} complex-valued vectors Yₙ_{_{ƒ}}_{,n}_{_{S}}(n_{R}), or 2N_{R} real-valued vectors. A separate feature vector may be output for separate REs (n_{ƒ}, n_{S}) and separate transmitted streams n_{T}. As a result, the output of initialization stage 210 may include N_{T} state tensors S_{0 n}_{_{ƒ}}_{,n}_{_{S}}(n_{T}), denoted as S₀(n_{T}) herein, jointly characterizing the (initial, as indicated by the subscript 0) state of the communication channel. Each state tensor has dimensions N_{F}×N_{S}×d. For concreteness and illustration, FIG. 2 depicts schematically three initial state tensors: state tensor S₀(n_{T}=1) 221, state tensor S₀(n_{T}=2) 222, and state tensor S₀(n_{T}=3) 223.

Initialization stage 210 may also use, as inputs, various additional data. In some embodiments, the inputs into initialization stage 210 may include positional encoding 204. FIG. 3 illustrates one example construction 300 of positional encoding 204 that may be used by OFDM model 140, according to at least one embodiment. Positional encoding 204 may characterize proximity of various REs (depicted as squares in FIG. 3) of resource grid 301 to pilot REs. Illustrated in FIG. 3 is a resource grid (or a portion of a larger resource grid) with 20 subcarriers and 12 OFDM symbols. White squares indicate REs used for data transmission and squares of various shadings indicate example pilot REs 306 (four streams are illustrated, for concreteness). A given pilot RE may be reserved to one of the streams, such that during transmission of a corresponding symbol, the respective TX antenna transmits a known sequence of bits while other antennas are not transmitting. As a result, pilot REs 306 may serve as carriers of reference data that is representative of the CSI of the system. Positional encoding 204 may be defined for each RE (or each data RE) and may include, e.g., (1) a distance (in RE units) from the respective RE to the closest pilot RE of individual streams along the subcarrier dimension of the resource grid, (2) a distance from the RE to the closest pilot RE of individual streams along the OFDM symbol dimension, and/or the like. For example, RE (7,6) may be characterized by the PE vector for the first stream (indicated as PE_{Stream-1} in FIG. 3) with two components, 1 and 3, indicating that the distance from the closest pilot RE for the first stream (8,9) is one along the subcarrier dimension and is three along the OFDM symbol dimension. PE vectors for other streams may be constructed in a similar manner. For example, the same RE (7,6) may be characterized by the PE vector for the fourth stream (indicated as PE_{Stream-4}) with components 0 and 4, indicating that the distance from the closest pilot RE for the first stream (7,10) is zero along the subcarrier dimension and is four along the OFDM symbol dimension.

In some embodiments, the positional encoding vectors may be agnostic about the signs of distances. In some embodiments, the positional encoding vectors may include signs. For example, a distance (along any dimension) may be taken with a positive sign provided that the pilot RE has a higher subcarrier number or a symbol number than the data RE and taken with a negative sign otherwise (or vice versa). In those instances where multiple pilot PEs are located at the same distance from a data RE, any suitable sign convention may be used for distance disambiguation. For example, as pilot RE (8,9) is located at positive distance +1 from data RE (7,6) along the subcarrier dimension whereas as another pilot RE (6,9) is located at equal but negative distance −1 from the same data RE (7,6), a sign convention may select the positive sign distance over the negative sign distance (or vice versa) for the data RE (7,6). With each positional encoding vector having dimension 2, positional encoding 204 may have dimensions N_{F}×N_{S}×2 for each of N_{T} transmitted streams.

In some embodiments, multiple pilot REs may be included in the positional encodings of various REs. For example, distances to two, three, etc., closest pilot REs may be included in positional encoding 204 of a given data RE. Correspondingly, the dimensions of positional encoding tensors may be N_{F}×N_{S}×4, N_{F}×N_{S}×6, etc., for each of the N_{T} transmitted streams.

Referring again to FIG. 2, additional inputs into initialization stage 210 may include a channel estimate 206 and/or noise power 208. Channel estimate 206 may include an estimated value Ĥₙ_{_{ƒ}}_{,n}_{_{S}}(n_{R}, n_{T}) of channel matrix that is estimated using pilot signals pₙ_{_{ƒ}}_{,n}_{_{S}}(n_{T}) transmitted with stream (n_{T}) over RE (n_{ƒ}, n_{S}) and detected by RX antenna np as the received signals yₙ_{_{ƒ}}_{,n}_{_{S}}(n_{R}). For example, the least square estimate gives the following channel estimate 206,

$${\hat{H}}_{{n}_{f} , {n}_{S}} ( {n}_{R} , {n}_{T} ) = \frac{{y}_{{n}_{f} , {n}_{S}} ( {n}_{R} ) {p}_{{n}_{f} , {n}_{S}}^{*} ( {n}_{T} )}{{\vert {p}_{{n}_{f} , {n}_{S}} ( {n}_{T} ) \vert}^{2}} .$$

Using channel estimate 206 Ĥₙ_{_{ƒ}}_{,n}_{_{S}}(n_{R}, n_{T}) as input into initialization stage 210 has been shown experimentally to improve performance of OFDM model 140, serving as a bootstrap for channel estimation. Computations performed by OFDM model 140 improve this estimate, Ĥₙ_{_{ƒ}}_{,n}_{_{S}}(n_{R}, n_{T})→Hₙ_{_{ƒ}}_{,n}_{_{S}}(n_{R}, n_{T}), by exploiting the subcarrier-symbol correlations of the channel matrix coefficients in the course of joint channel estimation and data detection for accurate reconstruction of the transmitted messages. Channel estimate Ĥₙ_{_{ƒ}}_{,n}_{_{S}}(n_{R}, N_{T}) is a complex tensor of dimensions N_{F}×N_{S}×N_{R} for each of N_{T} transmitted channels.

Noise power estimate Wₙ_{_{ƒ}}_{,n}_{_{S}}(n_{R}) 208 may be a tensor of dimensions N_{F}×N_{S}×N_{R} with elements that may be set equal to the same value W₀. The noise power W₀ may be a real number measured in decibels with the logarithmic scale used to facilitate operations over large ranges of signal-to-noise ratio (SNR). In some embodiments, the noise power W₀ may be estimated using signals received at unused REs, which are not associated with any streams and are, therefore, representative of the noise in the system.

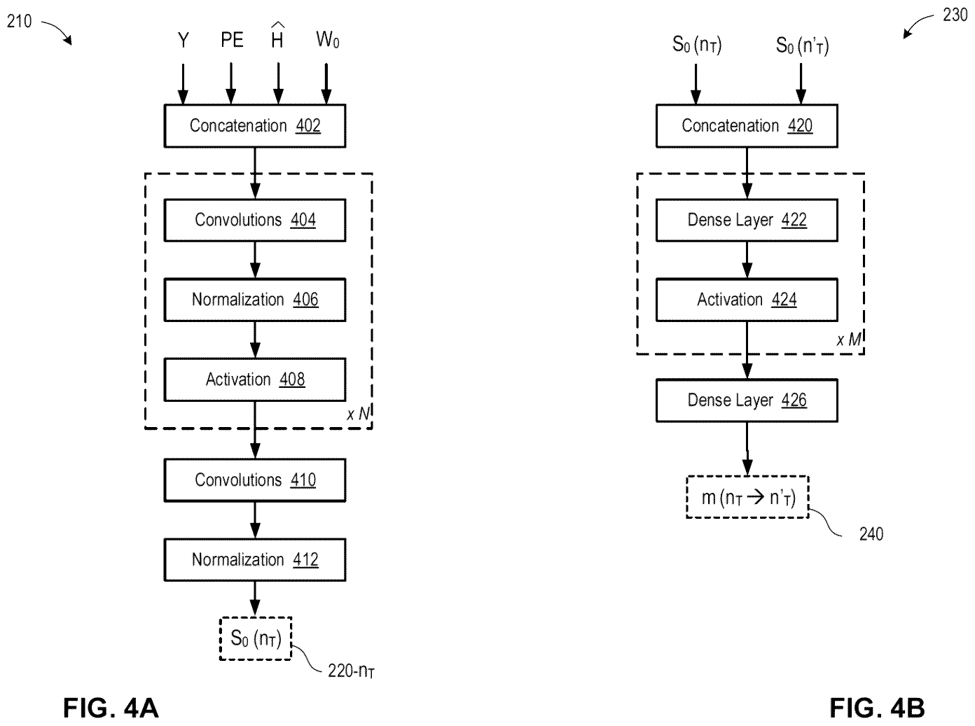

FIG. 4A illustrates an example architecture of the initialization stage 210 of OFDM model 140 of FIG. 2, according to at least one embodiment. In some embodiments, as illustrated in FIG. 4A, initialization stage 210 may use convolution techniques. The inputs to initialization stage 210, e.g., received signals (Y), positional encoding (PE), channel estimate (Ĥ), noise power estimate (W₀), may undergo concatenation 402. Real and imaginary parts of complex-valued inputs (e.g., Y and Ĥ) may be extracted and concatenated. Concatenated inputs may undergo one or more blocks of neural operations, each block including a layer of convolutions 404, an optional layer of normalization 406 (e.g., layer normalizations or batch normalizations), and an activation layer 408. Convolutions 404 may be separable convolutions used to reduce complexity of the inputs. Convolutions 404 may apply kernels (filters) of dimensions 3×3, 4×4, or some other suitable dimension. The number of kernels may be 64, 256, 512, or some other number. Activation layer 408 may deploy a rectified linear unit function (ReLU) or some other activation function. Blocks of layers 404-408 may be repeated N=2, 3, etc., or some other number of times followed by another layer of convolutions 410 (e.g., separable convolutions) and normalization 412. The layer of convolutions 410 may use d filters, where d is the feature dimension of the output state tensor S₀(n_{T}) 220-n_{T}. Initialization stage 210 may be applied N_{T} times, once for each transmitted stream. In some embodiments, the received signals Y and noise power estimate W₀ inputs into initialization stage 210 may be the same for all streams while positional encoding PE and channel estimate Ĥ may be stream-specific, e.g., as disclosed above in conjunction with FIG. 2. The N_{F}×N_{S}×d output state tensor S₀(n_{T}) carries channel information together with data transmitted by the TX stream n_{T}.

Referring to FIG. 2, state tensors 220-1, 220-2, 220-3, etc., may be processed by an inter-stream interference identification stage 230, provided that N_{T}>1 (No inter-stream interference identification stage is used if N_{T}=1). Inter-stream interference identification stage 230 may process pairs of state tensors 220-x to generate inter-stream interference features mₙ_{_{ƒ}}_{,n}_{_{S}}(n_{T}→n_{T}′) for N_{T}(N_{T}−1)/2 pairs n_{T}, n_{T}′ of transmitted streams. FIG. 4B illustrates an example architecture of the inter-stream interference identification stage 230 of OFDM model 140 of FIG. 2, according to at least one embodiment. In some embodiments, as illustrated in FIG. 4B, inter-stream interference identification stage 230 may use one or more dense (fully-connected) layers. The inputs to inter-stream interference identification stage 230 may include pairs of state tensors S₀(n_{T}) and S₀(n_{T}′) that undergo concatenation 420. Concatenated inputs may be processed using one or more blocks of neural operations, each block including a dense layer 422 and an activation layer 424. Activation layer 424 may deploy ReLU function or some other suitable activation function. Blocks of layers 422-424 may be repeated M=2, 3, etc., or some other number of times followed by another dense layer 426. In some embodiments, dense layer(s) 422 may have 256 neurons whereas the final dense layer 426 may have d_{M} neurons (e.g., d_{M}=64 or some other number), which may also be the size of the inter-stream interference feature output mₙ_{_{ƒ}}_{,n}_{_{S}}(n_{T}→n_{T}′) 240 of the inter-stream interference identification stage 230. The d_{M}-dimensional feature vector mₙ_{_{ƒ}}_{,n}_{_{S}}(n_{T}→n_{T}′) may be computed for each RE of the resource grid and each pair of the transmitted streams, e.g., sequentially, using one instance of the inter-stream interference identification stage 230, or in parallel, using two or more instances of the inter-stream interference identification stage 230. The inter-stream interference feature output 240 carries information about interference between a respective pair of transmitted channels n_{T}, n_{T}′. In some embodiments, inter-stream interference identification stage 230 may be replaced (or augmented) with a self-attention processing.

With a continuing reference to FIG. 2, an inter-stream interference aggregation function 250 may combine inter-stream interference feature outputs 240, obtained for a given transmission stream n_{T} and various other transmission streams n_{T}′. In some embodiments, the aggregation may be performed by averaging individual inter-stream interference features,

$${M}_{{n}_{f} , {n}_{S}} ( {n}_{T} ) = \frac{1}{{N}_{T} - 1} {\sum }_{{n}_{T}^{′} \neq {n}_{T}} {m}_{{n}_{f} , {n}_{S}} ( {n}_{T} \to {n}_{T}^{′} ) .$$

In some embodiments, other types of aggregation may be performed, such as computing a geometric mean of individual inter-stream interference features or using some other permutation-invariant aggregation function. The aggregated inter-stream interference tensor 260 may have dimensions N_{F}×N_{S}×d_{M}.

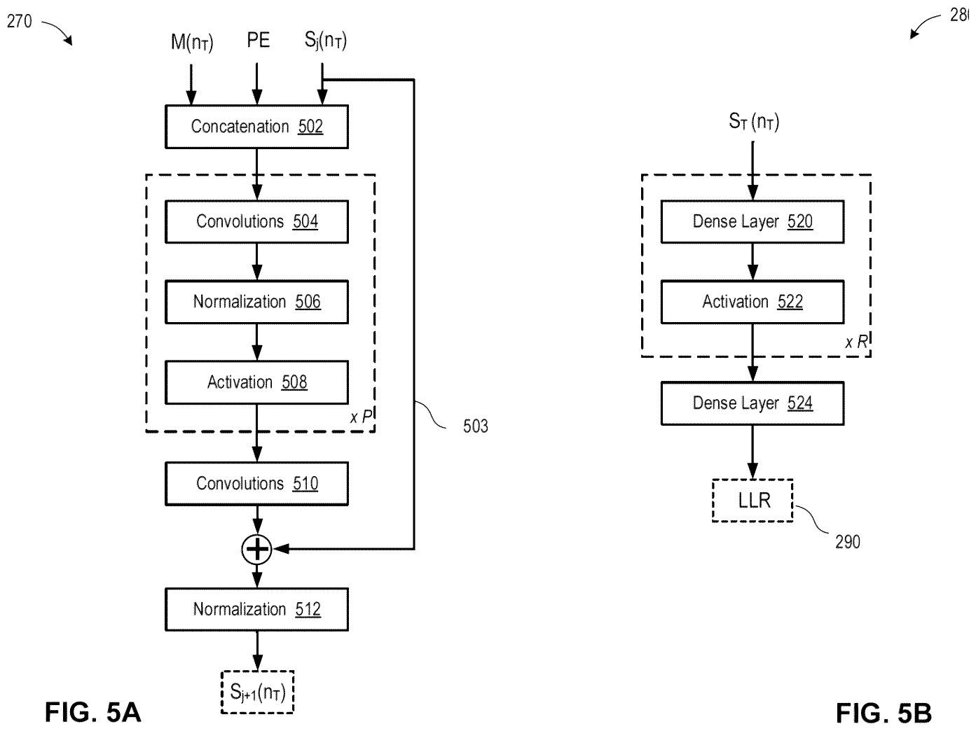

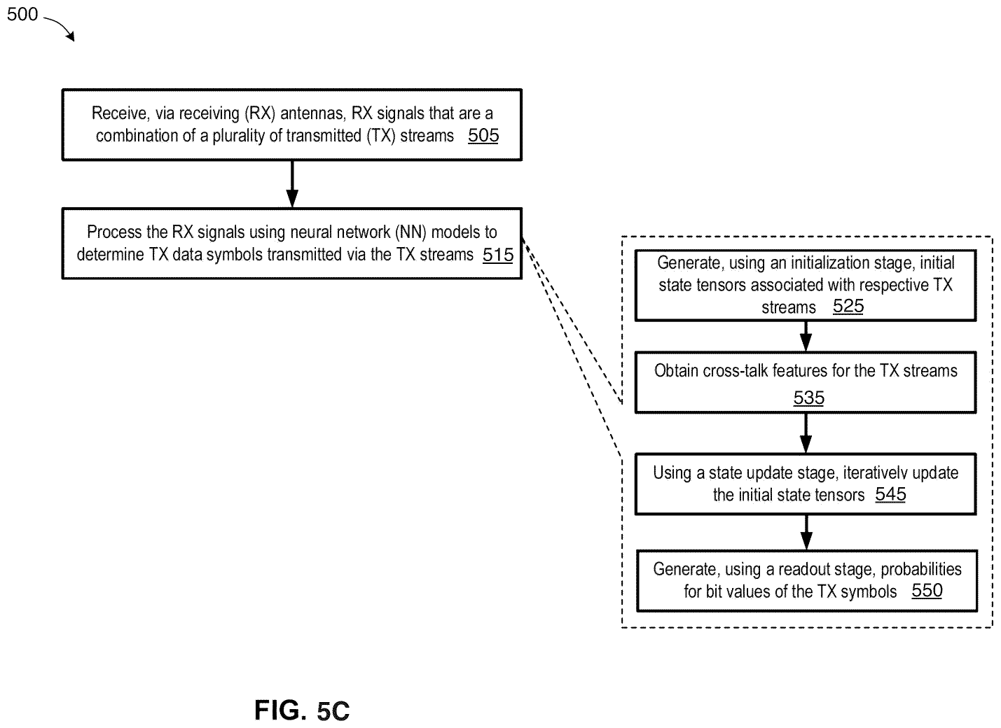

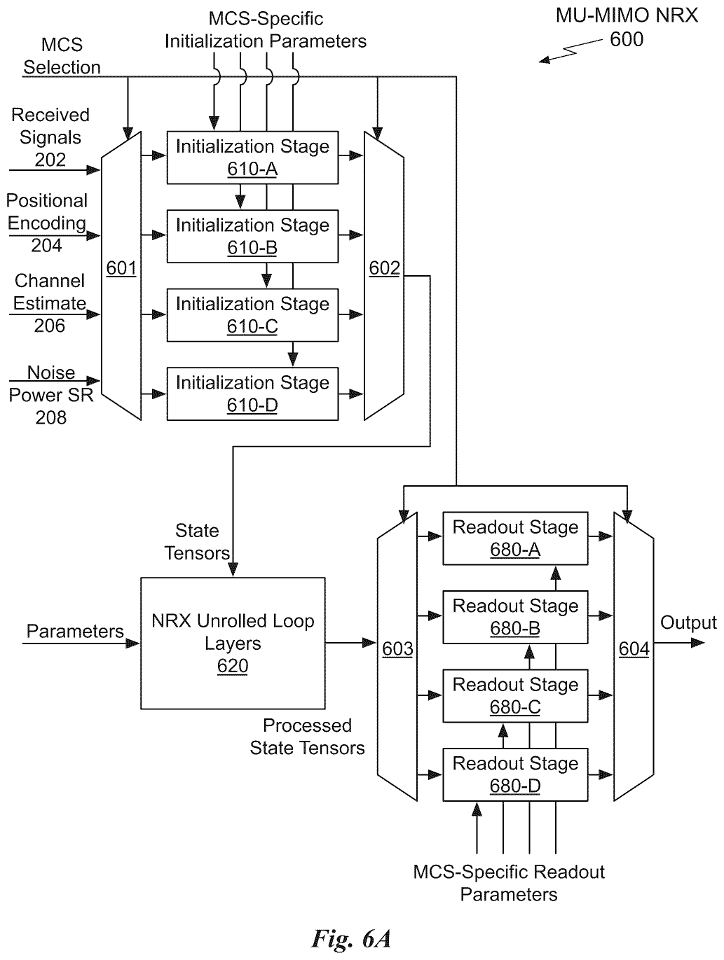

The aggregated inter-stream interference tensor Mₙ_{_{ƒ}}_{,n}_{_{S}}(n_{T}) 260 may be combined with a respective state tensor S₀(n_{T}) 220-n_{T} and processed by state update stage 270, which updates the state tensor S₀(n_{T})→S₁(n_{T}) (and similarly during later iterations, Sⱼ(n_{T})→Sⱼ₊₁(n_{T})). An additional input into state update stage 270 may include a copy of positional encoding 204. FIG. 5A illustrates an example architecture of state update stage 270 of OFDM model 140 of FIG. 2, according to at least one embodiment. In some embodiments, as illustrated in FIG. 5A, state update stage 270 may use convolution techniques. The inputs to state update stage 270, e.g., inter-stream interference tensor M(n_{T}), positional encoding (PE), and state tensor S₀(n_{T}) (or Sⱼ(n_{T}) in later iterations) may undergo concatenation 502. Concatenated inputs may then undergo one or more blocks of neural operations, each block including a layer of convolutions 504, a layer of normalization 506, and an activation layer 508. Convolutions 504 may be separable convolutions used to reduce complexity of the inputs. Convolutions 504 may apply kernels (filters) of dimensions 3×3, 4×4, or some other dimension. The number of kernels may be 256, 512, or some other number. Activation layer 508 may deploy ReLU function or some other activation function. Blocks of layers 404-408 may be repeated P=2, 3, etc., times or some other number of times followed by another layer of convolutions 510 (e.g., separable convolutions) and normalization 512. The layer of convolutions 510 may use d filters, where d is the feature dimension of the updated state tensor S₁(n_{T}) (or Sⱼ₊₁(n_{T}) in later iterations). In some embodiments, state update stage 270 may deploy a skip connection 503 that adds the initial state tensor S₀(n_{T}) (or, Sⱼ(n_{T}), for later iterations) to the output of the layer of convolutions 510. This enables addressing the gradient vanishing problem during training of the OFDM model. State update stage 270 may be applied N_{T} times, once for each transmitted stream, and enables exploring subcarrier-symbol correlation of channel coefficients while taking into account inter-stream interference via the inter-stream interference tensor. The N_{F}×N_{S}×d output state tensor S₁(n_{T}) (or Sⱼ₊₁(n_{T}) in later iterations) carries channel information together with data transmitted by the TX stream n_{T}.

With a continued reference to FIG. 2, operations of inter-stream interference identification stage 230, inter-stream interference aggregation 250, and state update stage 270 may be performed for multiple, T, iterations, e.g., T=2, 3, 6, 10 iterations, or some other empirically determined number of times. In some embodiments, number T of iterations may be determined dynamically. For example, further iterations may be stopped once the set of state tensors {Sⱼ(n_{T})} output by the most recent iteration differs from the output of the preceding iteration {Sⱼ₋₁(n_{T})} by an amount that is below a target threshold, e.g., once an average relative change of the state tensor elements (across different streams and REs) falls below a certain empirically set value, e.g., 1%, 2%, 5%, and/or the like.

Once the last (Tth) iteration has been performed, the output S_{T}(n_{T}) of the state update stage 270 of the last iteration may be input into a readout stage 280 to obtain a vector \hat{X}ₙ_{_{ƒ}}_{,n}_{_{S}}(n_{T}) that represents a reconstruction of the transmitted vector Xₙ_{_{ƒ}}_{,n}_{_{S}}(n_{T}) or a reconstruction of K bits assigned to symbol X transmitted via stream n_{T} over each RE (n_{ƒ}, n_{S}) of the resource grid. In some implementations, the output of the readout stage may include probabilities p₀ and p₁=1−p₀ of various bit values (0 and 1) of vector \hat{X}ₙ_{_{ƒ}}_{,n}_{_{S}}(n_{T}); a bit value with the largest probability may be selected while the specific values p₀ and p₁ may be treated as confidence levels of reconstruction of the respective bits values.

FIG. 5B illustrates an example architecture of the readout stage 280 of OFDM model 140 of FIG. 2, according to at least one embodiment. In some embodiments, as illustrated in FIG. 5B, readout stage 280 may deploy one or more dense (fully-connected) layers. The input to readout stage 280, the final state tensor S_{T}(n_{T}), may be processed using one or more blocks of neural operations, each block including a dense layer 520 and an activation layer 522. Activation layer 522 may deploy ReLU function or some other suitable activation function. Blocks of layers 520-522 may be repeated R=2, 3, etc., or some other number of times followed by another dense layer 524. In some embodiments, dense layer(s) 520 may have 256 neurons whereas the final dense layer 524 may have K neurons (the number of bits in each symbol). The final dense layer 524 may output log-likelihood ratios (LLR) 290 of probabilities of different bits of a given symbol. The log-likelihood ratios 290 may then be used to identify the most probable bit values of transmitted symbols and the confidence levels for the identified bits.

Various additional embodiments are within the scope of the instant disclosure. The architecture and training techniques for the OFDM model may be used with multiple modulation schemes. In some embodiments, inputs into the OFDM model omit some of the inputs disclosed in conjunction with FIGS. 2-5. For example, channel state estimate 206 may be omitted to force the OFDM model to learn (and use in inference) how to determine channel state information directly from received signals 202 and positional encoding 204. In such embodiments, the number T of the performed state update iterations may be increased compared with embodiments that deploy the channel state estimates.

In some embodiments, training of the OFDM model may be performed for a certain number of transmitted streams N_{T}, subcarriers N_{F}, and/or OFDM symbols N_{S}, whereas the trained OFDM model may be used with a different number of transmitted streams, subcarriers, and/or OFDM symbols. In some embodiments, training may be performed using training data for multiple different numbers of the transmitted streams. In those instances where the number of streams N_{T} is variable, normalization operations performed by various NN stages of the OFDM model, e.g., as illustrated in conjunction with FIGS. 4-5, may be layer normalizations rather than batch normalizations, to avoid constraints associated with training sets in a batch having the same number of transmitted streams.

During training, a suitably chosen loss function 156 may be deployed to evaluate probabilities p₁ and p₀ output by readout stage 280 and compare the probabilities to ground truth labels x₁ and x₀ for the corresponding bits (e.g., where x₁=1, x₀=0, when the bit has value 1, and x₁=0, x₀=1, when the bit has value 0), such as the binary cross entropy (BCE) loss function 156,

$$B C E = - \frac{1}{{N}_{0}} \sum ( {x}_{1} log {p}_{1} + {x}_{0} log {p}_{0} ) ,$$

where the sum is taken over N₀ bits of a training input, e.g., N_{T}×N_{F}×N_{S}×K bits (minus pilot bits). The computed values of loss function 156 may be used in various techniques of backpropagation, gradient descent, and/or the like, that modify various parameters of OFDM 140 (and, in particular, initialization stage 210, inter-stream interference identification stage 230, state update stage 270, and/or readout stage 280) in a direction that reduces the loss function value. In some embodiments, during training, the readout stage 280 may be applied after every iteration of OFDM model 140 (as disclosed in conjunction with FIG. 2) and used to update the loss function, e.g., calculate the mean loss over all iterations. Such aggregation of the loss function over different iterations may have an advantage of improving stability of the training process. In some embodiments, OFDM model 140 may be trained using a known set of TX data symbols, e.g., generated by training engine 152 (FIG. 1). In some embodiments, OFDM model 140 may be trained using an unknown set of TX data symbols. For example, ground truth labels, which are used during training, may be obtained by using one or more maximum-likelihood receiver algorithms (so that no prior knowledge of TX symbols is required). In some embodiments, forward error correction codes may be used to correct errors in the reconstructed ground truth labels.

FIG. 5C is a flow diagram of example method 500 of using neural network models for transmitted signal determination in communication systems that deploy orthogonal frequency division multiplexing, according to some embodiments of the present disclosure. Method 500 may be performed by one or more processing units (e.g., CPUs and/or GPUs), which may include (or communicate with) one or more memory devices. In at least one embodiment, method 500 may be performed by processing units of receiving device 130 and/or training server 150 in FIG. 1. In at least one embodiment, processing units performing method 500 may be executing instructions stored on a non-transient computer-readable storage media. In at least one embodiment, method 500 may be performed by multiple processing threads (e.g., CPU threads and/or GPU threads), each thread executing one or more individual functions, routines, subroutines, or operations of the method. In at least one embodiment, processing threads implementing method 500 may be synchronized (e.g., using semaphores, critical sections, and/or other thread synchronization mechanisms). Alternatively, processing threads implementing method 500 may be executed asynchronously with respect to each other. Various operations of method 500 may be performed in a different order compared with the order shown in FIG. 5C. Some operations of method 500 may be performed concurrently with other operations. In at least one embodiment, one or more operations shown in FIG. 5C may not always be performed.

At block 505, a receiving device performing method 500 may receive, via a plurality of RX antennas (e.g., antennas 131-x in FIG. 1), a plurality of RX signals (e.g., signals Yₙ_{_{ƒ}}_{,n}_{_{S}}(n_{R})). Each RX signal may be received over a respective resource element (RE) (n_{ƒ}, n_{S}) of a resource grid. Individual REs of the resource grid may be associated with different radio frequency subcarriers n_{ƒ} and/or data symbols n_{S}. The plurality of RX signals may be a combination (e.g., a superposition, in the instances of linear transmission/reception) of a plurality of transmitted (TX) streams (e.g., carrying signals Xₙ_{_{ƒ}}_{,n}_{_{S}}(n_{T})).

At block 515, method 500 may continue with processing units of the receiving device processing the plurality of RX signals using one or more NN models to determine a plurality of TX data symbols transmitted via the plurality of TX streams. In some embodiments, the plurality of TX data symbols may include a plurality of TX pilot symbols transmitted at predetermined RE positions of the resource grid (e.g., as illustrated in FIG. 3). In some embodiments, an input into the one or more NN models may include a positional encoding data characterizing positions of the TX data symbols within the resource grid relative to at least some of the plurality of TX pilot symbols. For example, the positional encoding data may include relative distances from the TX data symbols to one or more closest stream-dependent pilot symbols (e.g., as described in conjunction with FIG. 3).

In some implementations, the positional encoding data may depend not only on the relative distances from the TX data symbols and the one or more pilot symbols but may depend on individual coordinates of the TX data symbols and one or more pilot symbols (absolute position encoding). The distances may be counted along a subcarrier dimension of the resource grid, a symbol dimension of the resource grid, or both. In some implementations, the positional encoding data may use sine and cosine functions to generate positional encoding data. In some implementations, the positional encoding data may include a learnable bias encoding that maps the relative distance R of the TX data symbols and TX pilot symbols to a value b=ƒ(R), where ƒ(R) is a suitable function (e.g., defined via a look-up table). This mapping may be learned during training and can be either a scalar or vector-valued function. In some implementations, the positional encoding data may include an ALiBi encoding that is similar to the relative bias encoding but with negative sign. In some implementations, the function ƒ(R) may map distances larger than a threshold distance to the same value. In some implementations, the positional encoding data may include rotary position encoding that includes a position-dependent rotation to generate the positional encoding data. The above examples are intended as a way of illustration and not limitation and various other positional encoding data may be used in addition to or instead of the above examples.

In some embodiments, the input into the one or more NN models may further include a channel state estimate (e.g., Ĥₙ_{_{ƒ}}_{,n}_{_{S}}(n_{R}, n_{T})). The channel state estimate may relate the plurality of RX signals to the plurality of TX data symbols. In some embodiments, the channel state estimate may be obtained using a subset of the plurality of RX signals corresponding to the TX pilot symbols (e.g., values yₙ_{_{ƒ}}_{,n}_{_{S}}(n_{R}), as described in conjunction with FIG. 2). In some embodiments, the input into the one or more NN models may also include a noise power estimate of a noise present in the plurality of RX signals.

In some embodiments, operations of block 515 may be performed as illustrated in the callout portion of FIG. 5C. More specifically, processing the plurality of RX signals using the one or more NN models may include, at block 525, generating, using an initialization stage (e.g., initialization stage 210 illustrated in FIG. 2 and FIG. 4A) of the one or more NN models, a plurality of initial state tensors 220-k. Each initial state tensor of the plurality of initial state tensors may be associated with a respective TX stream of the plurality of TX streams. In some embodiments, the initialization stage may include one or more convolutional neuron layers (e.g., as described in conjunction with FIG. 4A).

At block 535, method 500 may include using the one or more NN models to obtain, for each TX stream of the plurality of TX streams, an inter-stream interference feature (e.g., mₙ_{_{ƒ}}_{,n}_{_{S}}(n_{T}→n′_{T}) or Mₙ_{_{ƒ}}_{,n}_{_{S}}(n_{T}). The inter-stream interference feature may be obtained using the plurality of the initial state tensors and may characterize a degree to which a corresponding TX stream is affected by other TX streams of the plurality of TX streams. In some embodiments, obtaining the inter-stream interference features for the plurality of TX streams may include processing the plurality of the initial state tensors using one or more dense neuron layers (e.g., as disclosed in conjunction with FIG. 4B).

At block 545, method 500 may include using a state update stage of the one or more NN models to iteratively update the plurality of initial state tensors (e.g., as disclosed in conjunction with FIG. 2). More specifically, an input into a first state update iteration may include the plurality of the initial state tensors S₀(n_{T}), and an input (e.g., Sⱼ(n_{T})) into an n+1st state update iteration may be based on an output of an nth state update iteration. Various additional inputs may also be used in conjunction with Sⱼ(n_{T}), such as positional encoding, inter-stream interference features, and/or the like. In some embodiments, the state update stage may include one or more convolutional neuron layers (e.g., as disclosed in conjunction with FIG. 5A). In some embodiments, each state update iteration may be performed separately (e.g., sequentially, in parallel, or as some combination thereof) for different TX streams of the plurality of TX streams.

At block 555, method 500 may include generating, using a readout stage of the one or more NN models, probabilities for bit values of the plurality of TX symbols. In some embodiments, the readout stage of the one or more NN models may include one or more dense neuron layers (e.g., as disclosed in conjunction with FIG. 5B).

In some embodiments, the plurality of TX streams may have a first number of streams (e.g., N_{T} TX streams) whereas the one or more NN models are trained to process a plurality of training TX data symbols transmitted via a plurality of training TX streams having a second number of streams (e.g., Ñ_{T}) different from the first number of streams.

### Modulation-Specific Components for Reconfigurable Neural Network-Based Receivers

In an embodiment, the OFDM NRX (OFDM model 140) is trained for a fixed modulation and coding scheme (MCS) for all users. Further, even static mixed MCSs (e.g. user-1 is configured to use QPSK, while user-2 uses a 16-quadrature amplitude modulation (QAM) modulation) are not supported due to the shared weights of all user input and output stages. However, the OFDM NRX can be extended using MCS-specific components that support changes in the MCS without requiring retraining. In the context of the following description, a reconfigurable MU-MIMO NRX includes the MCS-specific components at an input and output stage (layer) with modulation independent intermediate layers between the input and output stages.

An MCS index I_{MCS} corresponds to a modulation order Qₘ that defines modulation properties of a carrier wave (amplitude and/or phase) for encoding data for transmission over a channel (link). More bits can be transmitted for each symbol as the signal quality of the channel increases. The MCS index also defines the coderate R (i.e., the error correction code) applied to the data. For some cases, the MCS index changes, but the modulation order remains the same (e.g., MCS=9 and MCS=10 are both QPSK modulations in the 5G NR standard). The MCS is dynamically adapted to optimize performance based on the channel conditions.

Therefore, for multi-user MIMO, an NRX needs to support not only different MCSs for different users but also support a dynamically changing MCS for one or more users, and the NRX must be able to re-configure the system within milliseconds (or even less). In an embodiment, changes in the modulation order Qₘ indicate changes in the MCS. The reconfigurable MU-MIMO NRX may be jointly trained for multiple MCSs and for system property variations. In an embodiment, different learned weights are associated with each system property variation and the different learned weights selectively input to the input and output stages as the system property variations change. The MCS-specific components in the reconfigurable MU-MIMO NRX support dynamically changing the MCS for each user while maintaining strong block-error-rate (BLER) performance.

Before transmission, each user is assigned an MCS index, the selection of which typically depends on the channel quality parameters. As the MCS-to-user association (scheduling) is typically controlled by higher-layer protocols, the scheduling procedure itself is not directly relevant for a discussion on physical layer NRX methods and hence not considered here. For what follows, assume that the ith user is assigned an individual modulation index I_{MCS,i} which implies a user-specific modulation order Q_{M,i}.

In 5G New Radio (NR), multi-user MIMO is realized with so-called demodulation reference signal (DMRS) ports where each data stream is assigned to a specific DMRS port. Henceforth, a simplified terminology is used without distinguishing between the terms layers, data streams and users. Thus, each active DMRS port across all users is treated equally as one active user (UE) with index i, which has an individual modulation and coding index I_{MCS,i}.

As an example, for 8 users and 4 possible modulation schemes per user (ignoring BPSK-like schemes, i.e., only QPSK, 16QAM, 64-QAM and 256-QAM modulation) this leads to

$$( \begin{matrix}11 \\ 8\end{matrix} ) = 165$$

different MCS-to-UE combinations, or even 4⁸=65536 combinations when considering the order of the MCS-to-UE association. Consequently, it is not feasible to train an individual NRX for each MCS-to-UE configuration. In contrast, in an embodiment, the reconfigurable MU-MIMO NRX may be trained for all possible MCS-to-UE associations.

Virtually all modern wireless communication standards apply forward error correction (FEC) decoding to correct transmission errors. Modern decoders function best when they are not only provided with hard-decision bit estimates, but also with reliability estimates which are typically represented by log-likelihood ratios (LLRs). Classical receivers typically apply a posteriori probability (APP) demapping or apply a low-complexity simplification thereof called MAXLOG demapping. The efficacy of a subsequent FEC decoder strongly depends on the quality of the LLRs, i.e., how well the LLR magnitudes (and signs) resemble the ground-truth error probability of some received signal for a given transmission channel.

With Gray-code labeled QAM constellations, as those used in the 5G NR standard, it is possible to construct bit labels such that higher modulation orders can be derived from a lower-order constellation point and all these higher-order constellation points share the bit label of the lower-order constellation point. For example, a 256-QAM demapper may be applied for demapping a QPSK constellation while only considering the first two bits corresponding to QPSK (further referred to as mismatched demapping). This effect has been used to support variable modulation orders by blanking out (masking) unused higher-order output LLRs. While the hard-decision bit estimates will be similar between mismatched and matched demapping (with a demapper for the correct MCS), the soft-decision LLR outputs will show different statistics and cannot be easily derived from each other. Note that there exist techniques for LLR correction which, however, require problem-specific parameter-tuning and impose additional effort to the detection problem which may be avoided by using a matched demapper in the first place. Further, the computational complexity of such a mismatched demapping approach is significantly larger when compared to a demapper that focuses only on the relevant QPSK symbols.

QPSK symbols may be transmitted over a complex Additive White Gaussian Noise (AWGN) channel to compare demapping with a matched demapper for QPSK and a demapper for a 256-QAM constellation. With the assumed Gray-code labeling, only the first two LLRs of the 256-QAM demapper may be used, which acts as a mismatched demapper. However, the distribution of LLR 0 (i.e., the estimate associated to the first bit of a symbol) is significantly different between the matched and mismatched demapper. When performing hard-decision bit estimation (i.e., evaluating the sign of the LLRs), both demappers will show the same bit error rate (BER). However, the LLRs from the matched demapper are more confident (larger magnitude). Matched LLRs typically translate into a better post-FEC error-rate performance.

While neural networks can in general learn (error-) distributions, inferring accurate LLR estimates for varying modulation schemes from the same neural network (or classical demapper) outputs is not trivial due to different MCS-specific (error-) distributions. An alternative is a masking approach which only selects the neural network outputs of the bit labels of the corresponding Gray-code labeled modulation order. The masking approach equals mismatched demapping as described above and may implicitly learn some modulation-specific LLR correction terms but only works sufficiently well with Gray-code labeled constellations. In contrast, the reconfigurable MU-MIMO NRX does not rely on Gray-code labeled constellations and avoids mismatched demapping as each modulation order has an MCS-specific component.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

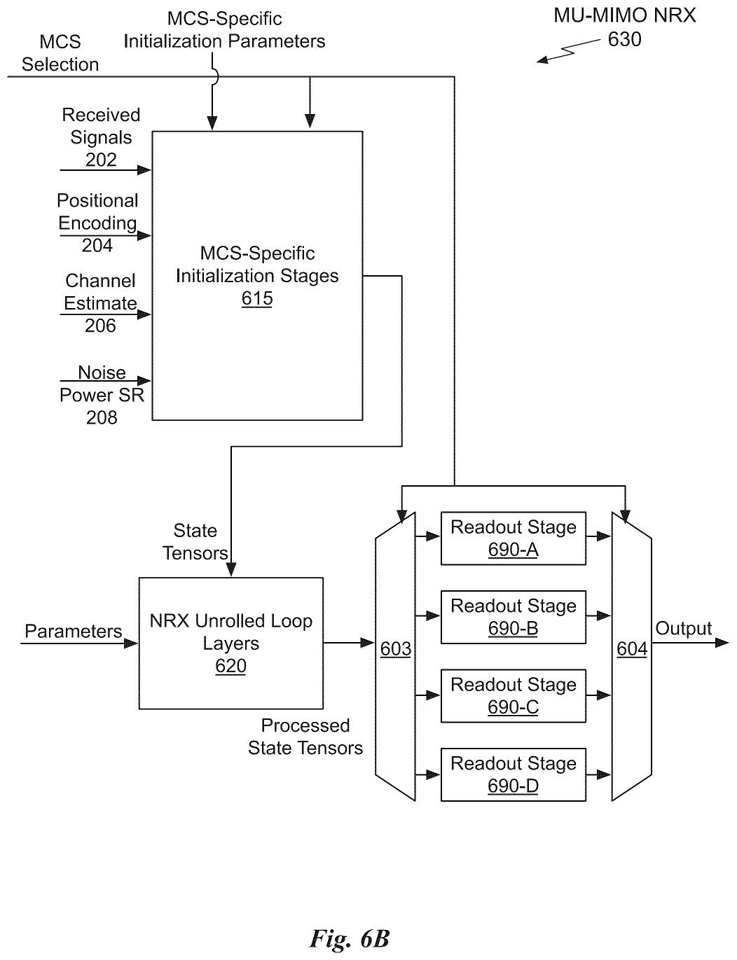

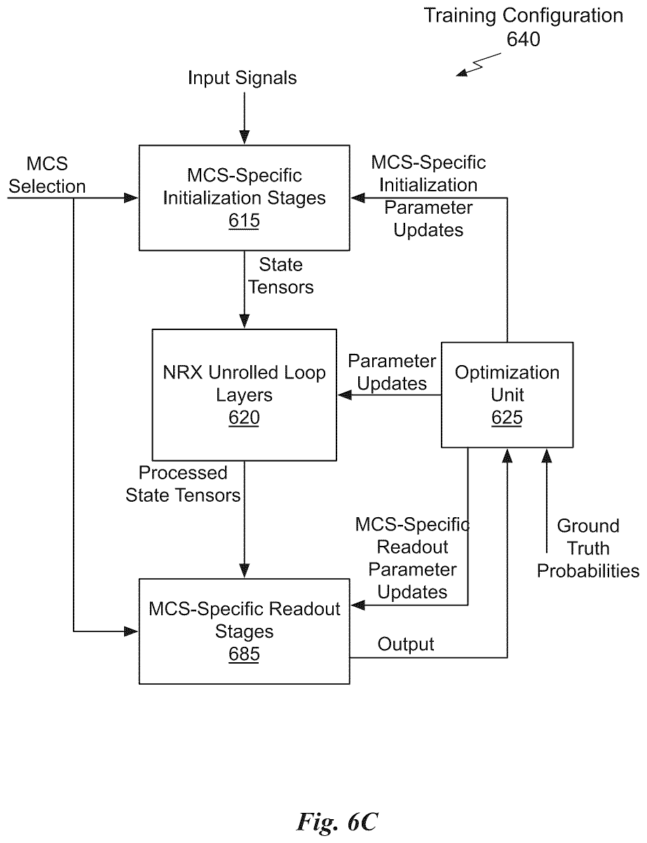

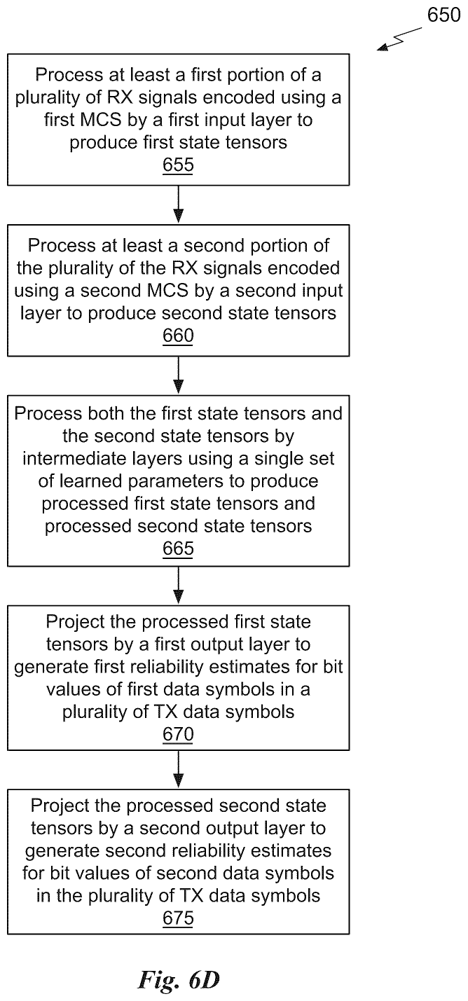

FIG. 6A illustrates an example block diagram of a MU-MIMO NRX (neural receiver) 600 with variable MCS support, according to at least one embodiment. The MU-MIMO NRX 600 includes multiplexers 601, 602, 603, and 604, initialization stages 610, NRX unrolled loop layers 620, and readout stages 680. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the MU-MIMO NRX 600 is within the scope and spirit of embodiments of the present disclosure.

As shown in FIG. 6A, compared with the example neural network architecture of the OFDM model previously described in conjunction with FIG. 2, the initialization stage 210 and readout stage 280 are replaced with the initialization stages 610 and the readout stages 680, respectively. Instead of supporting a single MCS for all users using the initialization stage 210 and readout stage 280, multiple initialization stages 610 and multiple readout stages 680 may support different MCSs. The multiplexers 601, 602, 603, and 604 selectively switch according to different users MCS indices which are used to generate MCS selection. As such, in an embodiment, the MU-MIMO NRX 600 enables or operates different network sub-components depending on the MCS selection. Q denotes the modulation order (i.e., how many bits are mapped to one symbol) which can be derived from the MCS index via look-up tables to provide the MCS selection.

The NRX unrolled loop (iteration) layers 620—which accounts for most of the computations and most of the learned parameters (weights) for the MU-MIMO NRX 600—are shared for all users and independent of the associated MCS. In an embodiment, the learned parameters for the NRX unrolled loop layers 620 are 90% of the learned parameters for the entire MU-MIMO NRX 600. The NRX unrolled loop layers 620 may be implemented using the same structure as a combination of the inter-stream interference identification stage 230, the inter-stream aggregation 250, and the state update stage 270 described in conjunction with FIGS. 2, 4B, and 6A. The initialization stages 610 may be implemented using the same structure as the initialization stage 210 described in conjunction with FIGS. 2 and 4A. In an embodiment, one or more of the initialization stages 610 is implemented using a different structure than another one of the initialization stages 610. In an embodiment, the initialization stages 610 are implemented using the same structure. In an embodiment, one or more of the initialization stages 610 is implemented as a CNN, GNN, MLP, or the like. In an embodiment, at least a portion of the NRX unrolled loop layers 620 is implemented as a CNN, GNN, MLP, or the like.

The readout stages 680 may be implemented using the same structure as the readout stage 280 described in conjunction with FIGS. 2 and 5B. In an embodiment, one or more of the readout stages 680 is implemented using a different structure than another one of the readout stages 680. In an embodiment, the readout stages 680 each receive a portion of the MCS-specific readout parameters corresponding to a dimension (number of LLRs per RE that is dependent on the MCS) of the output for the readout stage 680. In an embodiment, one or more of the readout stages 680 is implemented as a transformer, CNN, GNN, MLP, or the like. In an embodiment, the readout stages 680 are implemented using the same structure (and unused bit probabilities for the MCS selection may be discarded). For example, if the MU-MIMO NRX 600 supports QPSK to 256-QAM, the readout stages 680 may always produce 8 LLRs and in the case of QPSK modulation, only the first 2 LLRs are accessed. In an embodiment, the same number of MCS-specific readout parameters are provided to each of the readout stages 680 by extending to the dimension of the highest modulation order with zero-padding. In an embodiment, all initialization stages 610 have the same output dimension, and all readout stages 680 have the same input dimension.

In an embodiment, each pair of initialization and readout stages, such as a pair including the initialization stage 610-A and the readout stage 680-A is MCS-specific and associated with learned MCS-specific initialization parameters

$${θ}_{init , {Q}_{M , {n}_{T}} .}$$

and readout parameters

$${θ}_{readout , {Q}_{M , {n}_{T}}} ,$$

respectively. For example, in an embodiment, the initialization stage 610-A and the readout stage 680-A may be trained for processing QPSK MCS. In an embodiment, the initialization stage 610-B and the readout stage 680-B are trained for processing 16-QAM MCS. In an embodiment, the initialization stage 610-C and the readout stage 680-C are trained for processing 64-QAM MCS. In an embodiment, the initialization stage 610-D and the readout stage 680-D are trained for processing 256-QAM MCS. In an embodiment, the NRX unrolled loop layers 620 are MCS independent and therefore process state tensors generated by any of the initialization input stages 680 according to a single set of learned parameters.

Using the MCS-specific initialization parameters

$${θ}_{init , {Q}_{M , {n}_{T}}}$$

changes a mapping of the input to the feature space used by the initialization stage 210 from

$${S}_{{n}_{T}}^{( 0 )} = {f}_{{θ}_{init}} ( Y , {P}_{{n}_{T}} , {N}_{0} , {\hat{H}}_{{n}_{T}} ) \qquad Eq . ( 1 )$$

to an MCS-specific mapping of the input to the feature space for the initialization stage 610:

$${S}_{{n}_{T}}^{( 0 )} = {f}_{{θ}_{init , {Q}_{M , {n}_{T}}}} ( Y , {P}_{{n}_{T}} , {N}_{0} , {\hat{H}}_{{n}_{T}} ) . \qquad Eq . ( 2 )$$

Note that the weight index Q_{M,n}_{_{T}} describes the MCS index associated with user n_{T}, i.e., the weights are MCS-specific, not user-specific.

In an embodiment, instead of including multiple initialization stages 610 in the MU-MIMO NRX 600, a single initialization stage 610 is used and the MCS-specific initialization parameters that are applied by the single initialization stage 610 are dynamically selected by a multiplexer controlled by the MCS selection. Similarly, in an embodiment, instead of including multiple readout stages 680 in the MU-MIMO NRX 600, a single readout stage 680 is used and the MCS-specific readout parameters that are applied by the single readout stage 680 are dynamically selected by a multiplexer controlled by the MCS selection. The single readout stage 680 would (i) implement the maximum number of LLR outputs for the largest supported MCS index, (ii) unused higher-order LLR estimates would be blanked for lower MCS, and (iii) the MCS-specific readout parameters would be extended to the largest output layer dimension, e.g., by zero-padding. In other embodiment, a combination of one or more initialization stages 610 with one or more multiplexers dynamically selecting MCS-specific initialization parameters for at least one of the one or more initialization stages 610 and one or more readout stages 680 may be included with one or more multiplexers dynamically selecting MCS-specific readout parameters for at least one of the one or more readout stages 680.

In an embodiment, the NRX unrolled loop layers 620 process the state tensors to generate an inter-stream interference feature and processed state tensors. In an embodiment, the variable-MCS NRX unrolled loop layers 620 performs iterative message-passing and aggregation using the inter-stream interference identification stage 230 and inter-stream aggregation 250 as implemented with the fixed MCS NRX shown in FIG. 2. Thus, the iteration layers in the NRX unrolled loop layers 620 are MCS-independent, as are the state vectors of all users Sₙ_{_{T}}^{(t)}. In an embodiment, one common MCS-independent set of parameters is used by the NRX unrolled loop layers 620 for any MCS-to-UE association.

Each of the MCS-specific readout stages 680 projects a portion of the processed state tensors for a specific MCS to generate bit reliability estimates (such as probabilities or logits represented as log-likelihood ratios (LLRs) [symbol] ∈R^{Q}^{_{M}}) for all bit values of the transmitted symbols of order Q_{M} for every layer n_{T} and every RE [n_{F}, n_{S}]. In an embodiment, the read-out stage 280 is implemented by an MLP, that individually processes the state vectors sₙ_{_{F}}_{,n}_{_{S}}_{,n}_{_{T}}^{(t)} of every RE and layer, such that

$${ℓ}_{{n}_{F} , {n}_{S} , {n}_{T}}^{( t )} = {MLP}_{readout} ( {s}_{{n}_{F} , {n}_{S} , {n}_{T}}^{( t )} ) ∀ {n}_{F} , {n}_{S} , {n}_{T} .$$

The readout stage 280 implements the parametric function

$${ℓ}_{{n}_{F} , {n}_{S} , {n}_{T}}^{( t ) ,} = {f}_{{θ}_{readout}} ( {s}_{{n}_{F} , {n}_{S} , {n}_{T}}^{( t )} ) ∈ {ℝ}^{{Q}_{M}} , \qquad ( 2 )$$

where θ_{readout} denotes the trainable parameters of the readout stage 280.

The MCS-specific readout stages 680 use modulation specific parameters

$${θ}_{readout , {Q}_{M , {n}_{T}}}$$

leading to

$${ℓ}_{{n}_{F} , {n}_{S} , {n}_{T}}^{( t )} = {f}_{{θ}_{readout , {Q}_{M , {n}_{T}}}} ( {s}_{{n}_{F} , {n}_{S} , {n}_{T}}^{( t )} ) ∈ {ℝ}^{{Q}_{M , {n}_{T}}} .$$

Note that the MCS-specific readout parameter (weight) index Q_{M,n}_{_{T}} describes the MCS index associated to user n_{T}, i.e., the readout parameters are MCS-specific, not user-specific. In contrast with the initialization stages 610 that output state tensors of the consistent dimensions for different MCSs, the shape of the output of the readout stages 680 is changed as e.g., for QPSK only Q_{M}=2 LLRs are provided while a 16-QAM results in Q_{M}=4 output LLRs. Furthermore, this technique can be applied also for any custom constellation, or any arbitrary bit-labeling, and does not necessarily require Gray-coded bit labels.

The initialization stages 610 and the readout stages 680 are not user-specific but MCS-specific, i.e., if two users share the same modulation order, they also share the same MCS-specific initialization and readout parameters. Thus, only one set of parameters per modulation order is required. In case of 5G N_{R}, the modulation orders are {“QPSK”, “16-QAM,” “64-QAM”, “256-QAM”}. Four different sets of MCS-specific initialization and readout parameters are sufficient to support the four modulation orders while a single set of parameters may be used for the NRX unrolled loop layers 620.

FIG. 6B illustrates another example block diagram of a MU-MIMO NRX 630 with variable MCS support, according to at least one embodiment. Compared with the MU-MIMO NRX 600, the MU-MIMO NRX 630 replaces the readout stages 680 with readout stages 690. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the MU-MIMO NRX 630 is within the scope and spirit of embodiments of the present disclosure.

The readout stages 690 are implemented using “classical” a posteriori probability (APP) demappings or approximations thereof such as MAXLOG demapping. The readout stages 690 are each configured using the MCS selection. Rather than being implemented as neural networks using learned parameters, assuming one complex-valued estimate per symbol is output of the NRX unrolled loop layers 620, the readout stages 690 execute algorithms and do not rely on learned parameters but are fully differentiable for integration into training procedures. In an embodiment, the MCS-specific initialization stages 615 are implemented as a single initialization neural network that receives the MCS selection and the multiplexers 601 and 602 are omitted. The single initialization neural network is trained to perform the operations of the initialization stages 610 to process the inputs (received signals 202, positional encoding 204, channel estimate 206, and noise power SR 208) using the MCS-specific initialization parameters and the MCS selection. Similarly, in an embodiment, the MCS-specific readout stages 680 are implemented as a single readout neural network that receives the MCS selection and the multiplexers 603 and 604 are omitted. The single readout neural network is trained to perform the operations of the readout stages 680 or 690 to process the processed state tensors using the MCS-specific readout parameters and the MCS selection.

The OFDM NRX (OFDM model 140), the MU-MIMO NRX 600, and the MU-MIMO NRX 630 architectures are fully differentiable and, hence, stochastic gradient descent (SGD) based training is straightforward. While additional considerations for training the variable-MCS MU-MIMO NRX 600 or 630, first the general training strategy of the existing single-MCS OFDM NRX is summarized. In an embodiment, the ADAM optimizer is used with a learning rate l=10⁻³ and the binary cross-entropy (BCE) loss function. Thus, the OFDM NRX can be seen as attempting to solve N_{F}×N_{S}×N_{T}×Q_{M} binary classification problems in parallel from the received signal Y. The BCE can be estimated by Monte-Carlo integration

$${ℒ}_{BCE} \approx - \frac{1}{B {N}_{F} {N}_{S} {N}_{T} {Q}_{M}} {\sum }_{k = 0}^{B - 1} {\sum }_{{n}_{F} = 1}^{{N}_{F}} {\sum }_{{n}_{S} = 1}^{{N}_{S}} {\sum }_{{n}_{T} = 1}^{{N}_{T}} {\sum }_{m = 0}^{{Q}_{M} - 1} [ {b}_{{n}_{F} , {n}_{S} , {n}_{T} , m}^{[ k ]} log ( σ ( {ℓ}_{{n}_{F} , {n}_{S} , {n}_{T} , m} ( {Y}^{[ k ]} ) ) ) + ( 1 - {b}_{{n}_{F} , {n}_{S} , {n}_{T} , m}^{[ k ]} ) log ( σ ( - {ℓ}_{{n}_{F} , {n}_{S} , {n}_{T} , m} ( {Y}^{[ k ]} ) ) ) ]$$

where B is the batch size, the superscript [k] is used to refer to the k^{th} batch sample (i.e., the k^{th} sample within the batch), and σ(⋅) is the logistic sigmoid function. [symbol] ₙ_{_{F}}_{,n}_{_{S}}_{,n}_{_{T}}_{,m}(Y) denotes the LLR computed by the detector from the received signal Y for the m^{th} bit of layer n_{T} transmitted over the RE [n_{F}, n_{S}]. As LLRs are binary logits, i.e., σ( [symbol] ₙ_{_{F}}_{,n}_{_{S}}_{,n}_{_{T}}_{,m}(Y) gives the corresponding probability for the bit to be equal to one given Y. For training, the loss is averaged over all iterations to ensure that inference of the receiver can be done for a flexible number of iterations.

To account for a flexible number of layers, a different number of active users is randomly sampled for every batch, i.e., per SGD iteration. Intuitively, the task of MU-MIMO detection becomes more complicated if a larger number of users is active and, therefore, in an embodiment, a triangular distribution is used for the number of active layers such that scenarios with many active layers occur more frequently. For training the variable-MCS MU-MIMO NRX 600 or 630, the training strategy is adapted such that the MCS-specific stages can be trained jointly. Note that the initialization stages 610 provide an input to the d_{S} dimensional feature space Sₙ_{_{T}}⁽⁰⁾ and the readout stages 680 or 690 perform the projection of the state back to LLRs [symbol] ₙ_{_{T}}. Both the initialization stages 610 and the readout stages 680 or 690 may be considered to be input/output (IO) layers.

FIG. 6C illustrates an example training configuration 640 for the MU-MIMO NRX 600, according to at least one embodiment. MCS-specific initialization stages 615 include one or more initialization stages 610. MCS-specific readout stages 685 include one or more readout stages 680 and/or 690. The training configuration 640 also includes the NRX unrolled loop layers 620 and an optimization unit 625. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the training configuration 640 is within the scope and spirit of embodiments of the present disclosure.

The MU-MIMO NRX 600 or 630 can be trained for a variety of system properties including number of receiver antennas, antenna patterns, pilot configurations, analog beamforming configurations, bit labeling, custom constellations, etc. Like the OFDM NRX, the MU-MIMO NRX 600 or 630 is trained with SGD-based empirical risk minimization on BCE loss. To ensure robust training for variable and mixed MCS scenarios, various numbers of active users are selected during training, where the users are associated with different MCSs. Furthermore, MCS-specific SNR offsets may be used to avoid having a batch loss that is dominated by higher-order MCS schemes. In an embodiment, additional inputs may be provided to the MU-MIMO NRX 600 or 630, such as an MCS index and the MCS-specific initialization stages 610 may be implemented with a multi-dimensional input embedding. When the MCS index is input to the MCS-specific initialization stages 610 and readout stages 680 or 690, the multiplexers 601, 602, 603, and 604 shown in FIG. 6A may be omitted and each initialization stage 610 and readout stage 680 or 690 will instead only process data for a predetermined subset of the MCS indices.

To obtain gradients for all MCS-specific initialization stages 615 and MCS-specific readout layers 685 and to train the MU-MIMO NRX 600 or 630 for all possible variable- and mixed-MCS scenarios, an MCS-to-UE association is randomly sampled for each batch. A straight-forward implementation is to identically and independently sample an MCS index for each user, uniformly from all possible modulation schemes. Alternatively, one may apply deterministic MCS-to-UE associations, or introduce correlated MCS sampling, e.g., to control the fraction of single- or mixed-MCS samples in the batch (e.g., ⅓ QPSK, ⅓ mixed MCS, ⅓ 16-QAM). An alternative training schedule may also update the IO layers sequentially in an alternating fashion (e.g., only QPSK followed by only 16-QAM, etc.), and select specific training parameters (as the SNR range) for each MCS-to-UE association.

An optimization unit 625 computes a loss function and generates parameter updates using gradient backpropagation. The parameters that are updated include at least one parameter for one of the initialization stages 610, the readout stages 680 or 690, and the NRX unrolled loop layers 620. In an embodiment, the optimization unit 625 computes a loss function based on BCE. In an embodiment, training starts with the highest modulation order, then freezes the parameters input to the NRX unrolled loop layers 620 and continues training parameters of the MCS-specific initialization stages 615 and MCS-specific readout layers 685 for lower modulation orders. In an embodiment, random MCS indices are selected for each sample in each batch to train the parameters for the MCS-specific initialization stages 615, the MCS-specific readout layers 685, and the NRX unrolled loop layers 620.

In an embodiment, an additional readout or output stage generates MCS-independent values for at least one of channel estimate errors, carrier offsets, and timing offsets that contribute to a second loss term. The MCS-specific readout stages 685 may include additional readout stages that output pre- and post-equalization signal-to-interference-plus-noise-ratio values which can be used by higher layers, e.g., for link adaptation (MCS selection) as well as scheduling.

In an embodiment, training converges faster using an additional loss term based on the MSE of the channel estimation error. In an embodiment, the additional readout stage predicts the channel estimate for each user and each RE. Because the channel estimation error is independent of the MCS scheme, the same readout may be used for all MCS configurations for the second readout given as

$${\hat{H}}_{{n}_{F} , {n}_{s} , {n}_{T}}^{( t )} = {f}_{{θ}_{readout , MSE}} ( {s}_{{n}_{F} , {n}_{S} , {n}_{T}}^{( t )} ) .$$

And the additional channel estimation loss is calculated as

$${ℒ}_{chest} \frac{1}{B {N}_{F} {N}_{S} {N}_{T}} {\sum }_{k = 0}^{B - 1} {\sum }_{{n}_{F} = 1}^{{N}_{F}} {\sum }_{{n}_{S} = 1}^{{N}_{S}} {\sum }_{{n}_{T} = 1}^{{N}_{T}} \vert {\hat{H}}_{{n}_{F} , {n}_{S} , {n}_{T}}^{[ k ] , ( t )} - {H}_{{n}_{F} , {n}_{S} , {n}_{T}}^{[ k ]} {\vert}^{2}$$

where Hₙ_{_{F}}_{,n}_{_{S}}_{,n}_{_{T}}_{,m}^{[k]} denotes the ground truth channel of user n_{T} and the k'th batch sample and at time index n_{S} and frequency index n_{F}.

During training, in an embodiment, the overall loss is calculated as

$$ℒ = {ℒ}_{BCE} + {αℒ}_{chest}$$

where α∈ [symbol] is a hyperparameter that allows to control the contribution of the channel estimation error loss to the total loss used for gradient computation. In an embodiment, the additional channel estimation loss improves the convergence during training.

In an embodiment, the MU-MIMO NRX 600 or MU-MIMO NRX 630 is trained to compensate for carrier—as well as timing offsets. There is no need for architectural changes but rather these effects are considered during training by either simulating such impairments or training on datasets derived from actual hardware. Optionally, additional readout stages 680 or 690 may be used to output estimates of carrier—and timing offsets. The estimates may be used for the computation of additional training loss terms such that the loss becomes

$$ℒ = {ℒ}_{BCE} + {αℒ}_{chest} + {βℒ}_{imp}$$

where [symbol] ᵢₘₚ is the additional loss on the impairment (e.g., the MSE loss of the estimated CFO) and β∈ [symbol] is an additional hyperparameter.

In an embodiment, performance of the MU-MIMO NRX 600 or 630 is sensitive to the SNR range during training. As the training loss not only depends on the noise variance No (inversely proportional to the SNR), but also strongly depends on the MCS, and performing MCS-specific SNR adjustments significantly improve the training convergence and its robustness. Higher losses (and higher error rates) are typically obtained for higher MCS at the same SNR. To compensate for higher loss from higher MCS batch samples, MCS-specific SNR offsets may be introduced. In an embodiment, the SNR is shifted in each batch sample depending on the (random) MCS-to-UE association. In an embodiment, the MCS-specific SNR offsets are additional hyperparameters of the training. In an embodiment, the loss is only computed from the LLRs of the MCS-specific readout stage 680 or 690 associated with each user. In case of multi-loss training, each readout (per iteration) uses the MCS index of the associated user.

An extension of NRX in general is end-to-end learning where the transmitted QAM constellations are learned together with the parameters for the MU-MIMO NRX 600 or 630. In an embodiment, the MU-MIMO NRX 600 or 630 be also used with learned constellations and/or with SNR dependent constellations where the SNR is an additional input parameter for the MCS-specific initialization stages 615.

FIG. 6D illustrates a flowchart of a method for 650 of using a NRX model for transmitted signal determination in communication systems, in accordance with an embodiment. Each block of method 650, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 650 is described, by way of example, with respect to the MU-MIMO NRX 600 of FIG. 6A and the MU-MIMO NRX 630 of FIG. 6B. However, this method may additionally or alternatively be executed by any one system, or any combination of systems, including, but not limited to, those described herein. Furthermore, persons of ordinary skill in the art will understand that any system that performs method 650 is within the scope and spirit of embodiments of the present disclosure.

At step 655, a first input layer processes at least a first portion of the plurality of the RX signals encoded using a first MCS to produce first state tensors. In an embodiment, a plurality of RX antennas receives the plurality of RX signals associated with at least one of a plurality of users or a plurality of data streams. In an embodiment, the first input layer processes the plurality of the RX signals and separates the at least the first portion from other portions. In an embodiment, one user transmits multiple data streams in the plurality of data streams.

At step 660, a second input layer processes at least a second portion of the plurality of the RX signals encoded using a second MCS to produce second state tensors. In an embodiment, the second input layer processes the plurality of the RX signals and separates the at least the second portion from other portions that include the at least the first portion. In an embodiment, the at least first portion and the at least second portion include the same RX signals in the plurality of the RX signals. In an embodiment, logic or circuitry receives and separates the plurality of the RX signals into the at least first portion and the at least second portion. In an embodiment, the at least first portion and the at least second portion are exclusive. In an embodiment, the first input layer comprises one of the initialization stages 610 and the second input layer comprises a different one of the initialization stages 610.

At step 665, intermediate layers processes both the first state tensors and the second state tensors using a single set of learned parameters to produce processed first state tensors and processed second state tensors. In an embodiment, the intermediate layers comprise the NRX unrolled loop layers 620. In an embodiment, the single set of learned parameters are trained for variations of system properties including at least one of receiver antennas, antenna patterns, analog beamforming configurations, bit labeling, pilot configurations, custom constellations, a number of MCS including the first MCS and the second MCS, and a number of users. In an embodiment, the single set of learned parameters is trained using gradient descent-based optimization.

At step 670, a first output layer projects the processed first state tensors to generate first reliability estimates for bit values of first TX data symbols in the plurality of TX data symbols. In an embodiment, the first input layer and the first output layer process the first portion using a first set of learned parameters and process a third portion of the plurality of the RX signals encoded using a third MCS using the first set of learned parameters. In an embodiment, the first set of learned parameters comprises one or more MCS-specific initialization parameters and one or more MCS-specific readout parameters for processing both the first MCS and the third MCS.

At step 675, a second output layer projects the processed second state tensors to generate second reliability estimates for bit values of second TX data symbols in the plurality of TX data symbols. In an embodiment, the first output layer comprises one of the readout stages 680 or 690 and the second output layer comprises a different one of the readout stages 680 or 690. In an embodiment, the first TX data symbols are associated with the first MCS and the second TX data symbols are associated with the second MCS. In an embodiment, the first output layer uses a first set of learned parameters that is specific to the first MCS to generate the first reliability estimates and the second output layer uses a second set of learned parameters that is specific to the second MCS to generate the second reliability estimates.

In an embodiment, the first input layer processes the first portion and the first output layer projects the processed first state tensors using a first set of learned parameters and the second input layer processes the second portion and the second output layer projects the processed second state tensors using a second set of learned parameters. In an embodiment, the first set of learned parameters comprises a first subset of the MCS-specific initialization parameters and the MCS-specific readout parameters that are associated with the first MCS. In an embodiment, the second set of learned parameters comprises a second subset of the MCS-specific initialization parameters and the MCS-specific readout parameters that are associated with the second MCS.

In an embodiment, the neural network receiver is trained by sampling active users that are each associated with one of a plurality of MCSs including at least the first MCS and the second MCS to construct training data comprising training RX signals, MCS selections associated with at least the first MCS and the second MCS, and ground truth reliability estimates. In an embodiment, the MCS selections comprise MCS indices. In an embodiment, the neural network receiver is trained by processing the training RX signals and the MCS selections by the neural network receiver model to generate predicted probabilities comprising the first probabilities and the second probabilities. In an embodiment, the neural network receiver is trained by updating the single set of learned parameters, the first set of parameters, and the second set of parameters to reduce differences between the ground truth reliability estimates and the predicted reliability estimates. In an embodiment, the updating comprises evaluating a binary cross entropy loss function and using gradient descent-based optimization. In an embodiment, a signal-to-noise ratio (SNR) training offset for a first MCS selection of the MCS selections is different than a second MCS selection of the MCS selections.

In an embodiment, an additional output layer computes MCS-independent values for at least one of channel estimates, signal-to-noise ratio (SNR), signal-to-interference-plus-noise ratio (SINR), carrier offsets, and timing offsets using the processed first state tensors and the processed second state tensors. In an embodiment, the MCS-independent values output by the additional output layer contribute to a second loss term. In an embodiment, the updating also reduces differences between the MCS-independent values and ground truth values included in the training data.

In an embodiment, the neural network receiver model is trained by processing training RX signals and the first MCS by the neural network receiver model to generate predicted reliability estimates, where the first MCS is a higher modulation order compared with the second MCS. In an embodiment, the neural network receiver model is trained by updating the single set of learned parameters, the first set of parameters, and the second set of parameters to reduce differences between ground truth bit labels and the predicted reliability estimates.

In an embodiment, the neural network receiver model is trained by sampling active users that are each associated with one of a plurality of MCSs including at least one of the second MCS and a third MCS of a modulation order that is lower compared with the first MCS to construct additional training data comprising additional training RX signals, MCS selections associated with at least the first MCS, the second MCS, and the third MCS, and additional ground truth reliability estimates. In an embodiment, the neural network receiver model is trained by processing the additional training RX signals and MCS selections by the neural network receiver model to generate additional predicted reliability estimates. In an embodiment, the neural network receiver model is trained by updating the first set of parameters and the second set of parameters to reduce differences between the additional ground truth reliability estimates and the additional predicted reliability estimates.

In an embodiment, at least one of steps 655, 660, 665, 670, or 675 is performed on a server or in a data center. In an embodiment, at least one of steps 655, 660, 665, 670, or 675 is performed within a cloud computing environment. In an embodiment, at least one of steps 655, 660, 665, 670, or 675 is performed for training, testing, or certifying a neural network employed in a machine, robot, or autonomous vehicle. In an embodiment, at least one of steps 655, 660, 665, 670, or 675 is performed on a virtual machine comprising a portion of a graphics processing unit. In an embodiment, at least one of steps 655, 660, 665, 670, or 675 is implemented to include advanced error correction, fault-tolerance, and self-healing capabilities.

As the network configuration in a practical setup can change dynamically within milliseconds, adaptive NRX architecture of the MU-MIMO NRX 600 and 630 are capable of supporting dynamic modulation and coding scheme (MCS) configurations without the need for any re-training and without additional inference cost. In an embodiment, the MU-MIMO NRX 600 and 630 are responsive to changes in MCS in less than 10 ms. In an embodiment, the MU-MIMO NRX 600 and 630 are responsive to changes in MCS in less than 1 ms.

Each of the MU-MIMO NRX 600 and 630 may be jointly trained for multiple MCSs and for system property variations, allowing the MU-MIMO NRX 600 and 630 to fit to varying modulation orders, while sharing the majority of weights (in the NRX unrolled loop layers 620) across modulation schemes. The MU-MIMO NRX 600 and 630 can process more general, non-Gray-code-labeled constellations, or custom constellations obtained from end-to-end learning. Note that although MCS-specific IO layers lead to a slightly increased number of weights, in an embodiment, the number of active weights (and, thus, the inference latency) is the same as for a single-MCS NRX, such as the OFDM model 140. Furthermore, site-specific fine-tuning may be performed to adapt the MU-MIMO NRX 600 and 630 to the specific environment which even allows for continuous performance improvement after deployment.

### Inference and Training Logic

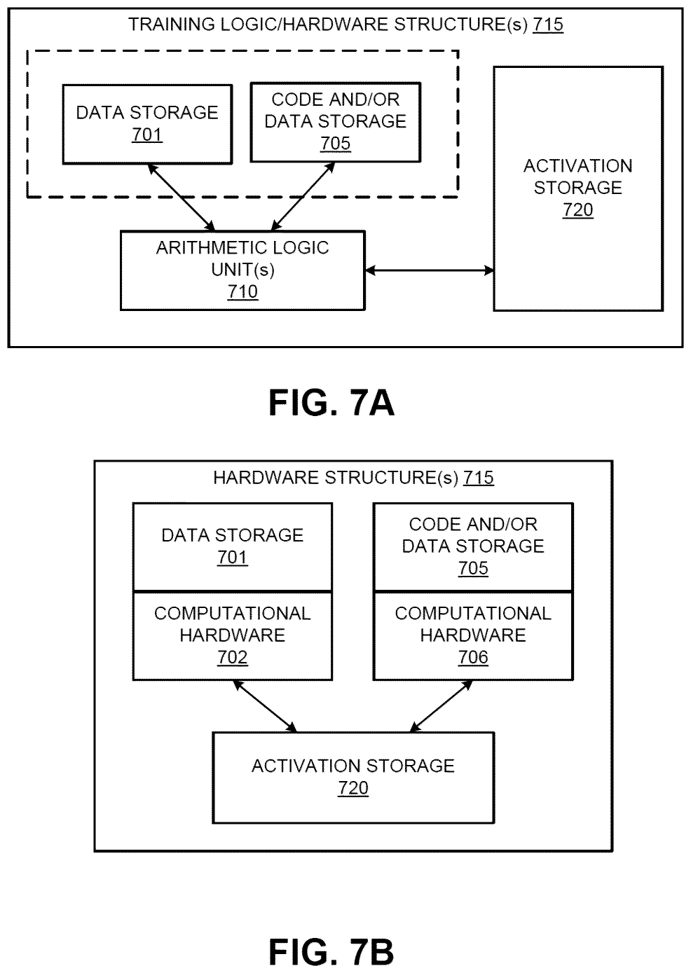

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating-point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

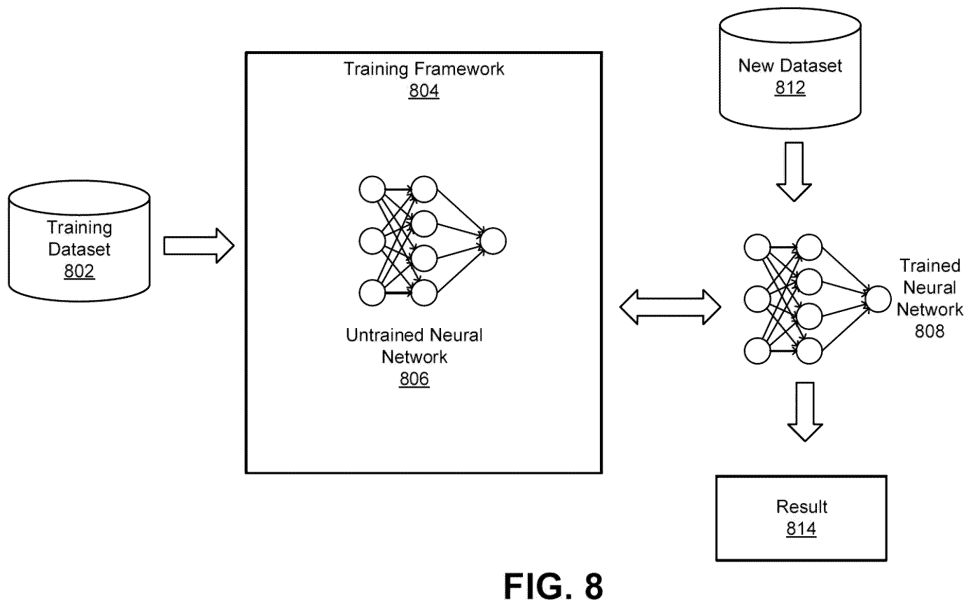

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

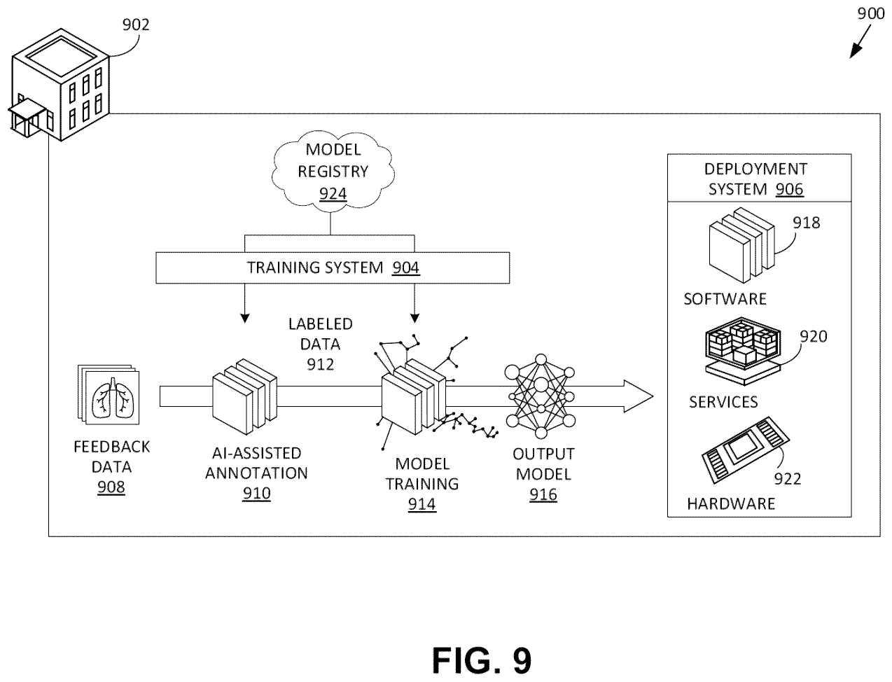

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

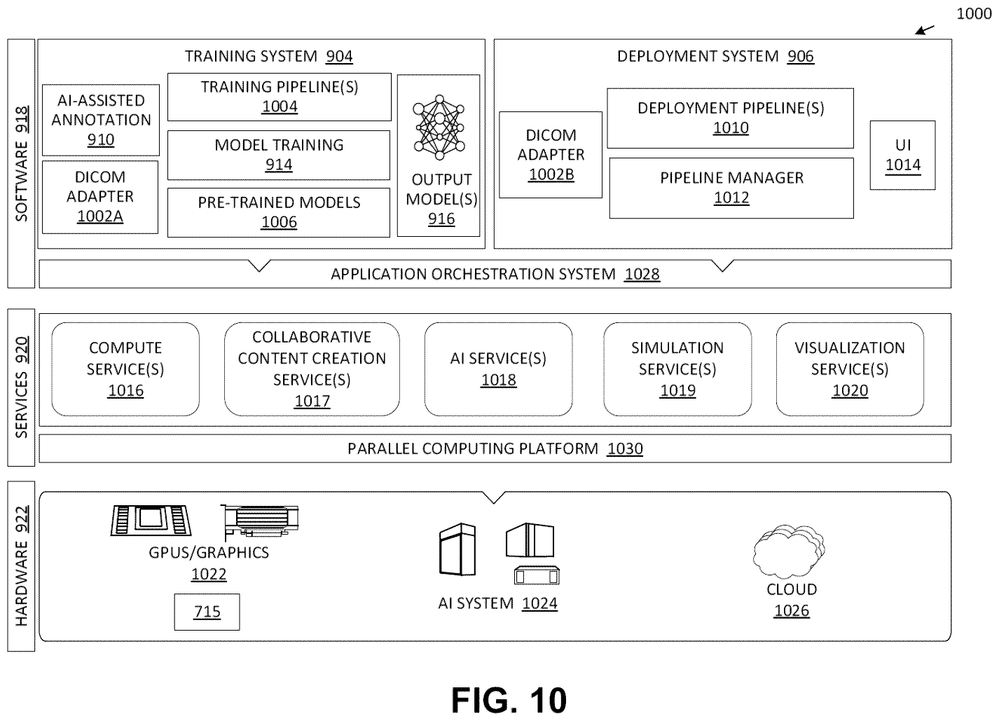

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNS)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A neural network receiver model configured to receive a plurality of received (RX) signals comprising a plurality of transmitted (TX) streams and determine a plurality of TX data symbols included in the plurality of TX streams, comprising:
a first input layer for processing at least a first portion of the plurality of the RX signals encoded using a first modulation and coding scheme (MCS) to produce first state tensors;
a second input layer for processing at least a second portion of the plurality of the RX signals encoded using a second MCS to produce second state tensors;
intermediate layers for processing both the first state tensors and the second state tensors using a single set of learned parameters to produce processed first state tensors and processed second state tensors;
a first output layer for projecting the processed first state tensors to generate first reliability estimates for bit values of first TX data symbols in the plurality of TX data symbols; and
a second output layer for projecting the processed second state tensors to generate second reliability estimates for bit values of second TX data symbols in the plurality of TX data symbols.

2. The neural network receiver model of claim 1, wherein the first TX data symbols are associated with the first MCS and the second TX data symbols are associated with the second MCS.

3. The neural network receiver model of claim 1, wherein the first input layer and the first output layer process at least the first portion using a first set of learned parameters and process at least a third portion of the plurality of the RX signals encoded using a third MCS using the first set of learned parameters.

4. The neural network receiver model of claim 1, wherein the first output layer uses a first set of learned parameters that is specific to the first MCS to generate the first reliability estimates and the second output layer uses a second set of learned parameters that is specific to the second MCS to generate the second reliability estimates.

5. The neural network receiver model of claim 1, further comprising a plurality of RX antennas that receive the plurality of RX signals associated with at least one of a plurality of users or a plurality of data streams.

6. The neural network receiver model of claim 1, wherein the single set of learned parameters are trained for variations of system properties including at least one of receiver antennas, antenna patterns, pilot configurations, analog beamforming configurations, bit labeling, custom constellations, a number of MCS including the first MCS and the second MCS, and a number of users.

7. The neural network receiver model of claim 1, wherein the single set of learned parameters is trained using gradient descent-based optimization.

8. The neural network receiver model of claim 1, wherein the first input layer processes at least the first portion and the first output layer projects the processed first state tensors using a first set of learned parameters and the second input layer processes at least the second portion and the second output layer projects the processed second state tensors using a second set of learned parameters.

9. The neural network receiver model of claim 8, wherein the neural network receiver model is trained by:
sampling active users that are each associated with one of a plurality of MCSs including at least the first MCS and the second MCS to construct training data comprising training RX signals, MCS selections associated with at least the first MCS and the second MCS, and ground truth reliability estimates;
processing the training RX signals and the MCS selections by the neural network receiver model to generate predicted probabilities comprising the first probabilities and the second probabilities; and
updating the single set of learned parameters, the first set of parameters, and the second set of parameters to reduce differences between the ground truth reliability estimates and the predicted reliability estimates.

10. The neural network receiver model of claim 9, wherein the MCS selections comprise MCS indices.

11. The neural network receiver model of claim 9, wherein the updating comprises evaluating a binary cross entropy loss function and using gradient descent-based optimization.

12. The neural network receiver model of claim 9, wherein a signal-to-noise ratio (SNR) training offset for a first MCS selection of the MCS selections is different than a second MCS selection of the MCS selections.

13. The neural network receiver model of claim 9, further comprising an additional output layer computes MCS-independent values for at least one of channel estimates, signal-to-noise ratio (SNR), signal-to-interference-plus-noise ratio (SINR), carrier offsets, and timing offsets using the processed first state tensors and the processed second state tensors.

14. The neural network receiver model of claim 13, wherein the updating also reduces differences between the MCS-independent values and ground truth values included in the training data.

15. The neural network receiver model of claim 13, wherein the neural network receiver model is trained by:
processing training RX signals and the first MCS by the neural network receiver model to generate predicted reliability estimates, wherein the first MCS is a higher modulation order compared with the second MCS;
updating the single set of learned parameters, the first set of parameters, and the second set of parameters to reduce differences between ground truth bit labels and the predicted reliability estimates;
sampling active users that are each associated with one of a plurality of MCSs including at least one of the second MCS and a third MCS of a modulation order that is lower compared with the first MCS to construct additional training data comprising additional training RX signals, MCS selections associated with at least the first MCS, the second MCS, and the third MCS, and additional ground truth reliability estimates;
processing the additional training RX signals and the MCS selections by the neural network receiver model to generate additional predicted reliability estimates; and
updating the first set of parameters and the second set of parameters to reduce differences between the additional ground truth reliability estimates and the additional predicted reliability estimates.

16. The neural network receiver model of claim 1, wherein the neural network receiver model is implemented on a server or in a data center and the plurality of RX signals are received by the server or the data center.

17. The neural network receiver model of claim 1, wherein the neural network receiver model is implemented within a cloud computing environment.

18. The neural network receiver model of claim 1, wherein the plurality of TX data symbols is determined for training, testing, or certifying a neural network employed in a machine, robot, or autonomous vehicle.

19. The neural network receiver model of claim 1, wherein the neural network receiver model is implemented on a virtual machine comprising a portion of a graphics processing unit.

20. The neural network receiver model of claim 1, wherein the neural network receiver model is implemented is implemented to include advanced error correction, fault-tolerance, and self-healing capabilities.

21. A method of determining a plurality of transmitted (TX) data symbols included in a plurality of TX streams, comprising:
receiving, at a neural network receiver (NRX) model, a plurality of received (RX) signals comprising the plurality of TX streams;
processing, by a first input layer of the NRX model, at least a first portion of the plurality of the RX signals encoded using a first modulation and coding scheme (MCS) to produce first state tensors;
processing, by a second input layer of the NRX model, at least a second portion of the plurality of the RX signals encoded using a second MCS to produce second state tensors;
processing, by intermediate layers of the NRX model, both the first state tensors and the second state tensors using a single set of learned parameters to produce processed first state tensors and processed second state tensors;
projecting, by a first output layer of the NRX model, the processed first state tensors to generate first reliability estimates for bit values of first TX data symbols in the plurality of TX data symbols; and
projecting, by a second output layer of the NRX model, the processed second state tensors to generate second reliability estimates for bit values of second TX data symbols in the plurality of TX data symbols.

22. The method of claim 21, wherein the first TX data symbols are associated with the first MCS and the second TX data symbols are associated with the second MCS.

23. The method of claim 22, wherein the first output layer uses a first set of learned parameters that is specific to the first MCS to generate the first reliability estimates and the second output layer uses a second set of learned parameters that is specific to the second MCS to generate the second reliability estimates.
